(19) United States
(12) Patent Application Publication
(10) Pub. No.: US 2017/0134959 A1
(43) Pub. Date: May 11, 2017

(54) WIRELESS COMMUNICATION SYSTEM, BASE STATION APPARATUS, AND METHOD FOR CONTROLLING WIRELESS COMMUNICATION SYSTEM

(71) Applicant: FUJITSU LIMITED, Kawasaki-shi (JP)

(72) Inventors: Yoshio Miura, Yokohama (JP); Kazunari Kobayashi, Yokohama (JP); Yuki Shinada, Saitama (JP); Hiroaki Maruyama, Sagamihara (JP)

(73) Assignee: FUJITSU LIMITED, Kawasaki-shi (JP)

(21) Appl. No.: 15/286,864

(22) Filed: Oct. 6, 2016

(30) Foreign Application Priority Data
Nov. 9, 2015 (JP) 2015-219573

(51) Int. Cl. H04W 16/08; H04W 8/00; H04W 24/02; H04W 16/32

(52) U.S. Cl. CPC H04W 16/08; H04W 16/32; H04W 8/005; H04W 24/02

(57) ABSTRACT

A wireless communication system includes a base station apparatus that forms a first cell and a base station apparatus that forms a second cell having an overlapping area with the first cell. A configuration managing unit executes a configuration change for the first cell or the second cell. When the configuration managing unit has executed the configuration change, a terminal count acquiring unit obtains a count of wireless mobile terminal devices located in the overlapping area between the first cell and the second cell. A configuration fixing unit fixes a configuration of the first cell or the second cell, or configurations of both of the first cell and the second cell, based on the count, obtained by the terminal count acquiring unit, of the wireless mobile terminal devices located in the overlapping area.

### CROSS-REFERENCE TO RELATED APPLICATION

This application is based upon and claims the benefit of priority of the prior Japanese Patent Application No. 2015-219573, filed on Nov. 9, 2015, the entire contents of which are incorporated herein by reference.

### FIELD

The embodiments discussed herein are related to a wireless communication system, a base station apparatus, and a method for controlling a wireless communication system.

### BACKGROUND

A base station apparatus in a wireless communication system has a wireless area (hereinafter referred to exemplarily as a cell) that serves as a range in which wireless communication can be performed via the base station apparatus. A communication area that eliminates a dead zone in which wireless communication by a wireless mobile terminal device is difficult to perform is formed by disposing the cells with no gaps allowed therebetween.

In order to dispose the cells with no gaps allowed therebetween, the cell formed by each base station apparatus has an area that overlaps a cell formed by an adjacent base station apparatus. Any wireless mobile terminal device located within such a cell overlapping area receives signals from all of the base station apparatuses that form the overlapping cells. Thus, in a wireless mobile terminal device located in the cell overlapping area, a signal from a base station apparatus to which the wireless mobile terminal device is connected is subject to interference by a signal from any base station apparatus other than the base station apparatus to which the wireless mobile terminal device is connected. This situation results in degraded communication quality.

Against this background, a function capable of freely controlling the cell, for example, an active antenna system, is gaining attention in order to achieve comfortable high-speed communication by reducing interference from any base station apparatus other than the base station apparatus to which the wireless mobile terminal device is connected. The base station apparatus having such a function can, for example, change a cell range or divide a cell. The base station apparatus capable of changing the cell range or dividing the cell will hereinafter be referred to as an “adaptive cell configuration base station apparatus”.

As an adaptive cell configuration base station apparatus, a known technique measures reception quality by changing a beacon radiation pattern and, on the basis of measurements, determines the radiation pattern. Such known techniques are described in Japanese National Publication of International Patent Application No. 2001-505025, for example.

Unfortunately, however, it is difficult for the known adaptive cell configuration base station apparatus to optimally change the cell range or divide the cell in order to reduce interference with adjacent cells. More specifically, because of difficulty involved in disposing the wireless mobile terminal devices within an area covered by the base station apparatus, specifically, within the cell and determining interference from adjacent base station apparatuses, the following cases may occur.

For one, when a base station apparatus expands the cell range in order to increase reception intensity of signals in a wireless mobile terminal device covered by the base station apparatus, interference affecting adjacent base station apparatuses may be augmented. In contrast, when a base station apparatus adjacent to a base station apparatus of interest expands the cell range, interference affecting the base station apparatus of interest from the adjacent base station apparatus may be augmented.

For another, even when a base station apparatus shrinks the cell range in order to reduce an interference area, reception intensity with respect to a wireless mobile terminal device is not changed because of an inadequately shrunk size, resulting in increased interference affecting the base station apparatus from an adjacent base station apparatus and wireless environment not being improved.

For still another, when the cell of a base station apparatus is divided in order to distribute load on a wireless channel, wireless mobile terminal devices may be connected unevenly with one part of the divided cell, resulting in inadequate load distribution.

### SUMMARY

According to an aspect of an embodiment, a wireless communication system includes: a first base station apparatus that forms a first wireless area; and

a second base station apparatus that forms a second wireless area having an overlapping area with the first wireless area, the first base station apparatus including: a first configuration changing unit that executes a configuration change for the first wireless area or the second wireless area; a terminal count acquiring unit that obtains, when the first configuration changing unit has executed the configuration change, a count of wireless mobile terminal devices located in the overlapping area between the first wireless area and the second wireless area; and a configuration fixing unit that fixes a configuration of the first wireless area or the second wireless area, or configurations of both of the first wireless area and the second wireless area, based on the count of the wireless mobile terminal devices located in the overlapping area, the count having been obtained by the terminal count acquiring unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a network configuration diagram of a wireless communication system;

FIG. 2 is a diagram for illustrating overlapping of cells between base station apparatuses;

FIG. 3 is a block diagram of the base station apparatus;

FIG. 4 is a block diagram illustrating details of a coordination control unit in a leading base station;

FIG. 5 is a block diagram illustrating details of the coordination control unit in a cooperating base station;

FIG. 6 is a diagram for illustrating expansion of a cell of the leading base station;

FIG. 7 is a table that depicts measurements taken when the cell of the leading base station is expanded;

FIG. 8 is a diagram for illustrating the expansion of the cell of the cooperating base station;

FIG. 9 is a table that depicts measurements taken when the cell of the cooperating base station is expanded;

FIG. 10 is a table that depicts the number of wireless mobile terminal devices connected with each base station apparatus for each change candidate;

FIG. 11 is a sequence diagram illustrating a process for selecting an optimal change candidate, performed by the communication system according to the first embodiment;

FIG. 12 is a sequence diagram illustrating a process for changing a cell range, performed by the communication system according to the first embodiment;

FIG. 13 is a flowchart that depicts a process for changing the cell range, performed by a wireless communication system according to a first modification;

FIG. 14 is a flowchart that depicts a process for changing the cell range, performed by a wireless communication system according to a second modification;

FIG. 15 is a table that depicts information used for selecting a change candidate in a third modification;

FIG. 16 is a sequence diagram illustrating a process for forming an overlapping area, performed by a communication system according to a second embodiment;

FIG. 17 is a diagram illustrating an exemplary status of cells in a wireless communication system according to a third embodiment;

FIG. 18 is a block diagram illustrating a coordination control unit in a leading base station according to the third embodiment;

FIG. 19 is a diagram illustrating a condition in which cells of cooperating base stations are expanded;

FIG. 20 is a table that depicts exemplary numbers of wireless mobile terminal devices affected by interference from each cooperating base station;

FIG. 21 is an exemplary diagram illustrating a distribution diagram of the wireless mobile terminal devices;

FIG. 22 is a diagram illustrating a condition of cells after division;

FIG. 23 is a sequence diagram illustrating a cell division process performed by the wireless communication system according to the third embodiment;

FIG. 24 is a hardware configuration diagram of the base station apparatus; and

FIG. 25 is a hardware configuration diagram of the wireless mobile terminal device.

### DESCRIPTION OF EMBODIMENTS

Preferred embodiments of the present invention will be explained with reference to accompanying drawings. It is understood that the wireless communication system, the base station apparatus, and the method for controlling a wireless communication system disclosed in this application by the preferred embodiments are illustrative only and not limiting.

### [a] First Embodiment

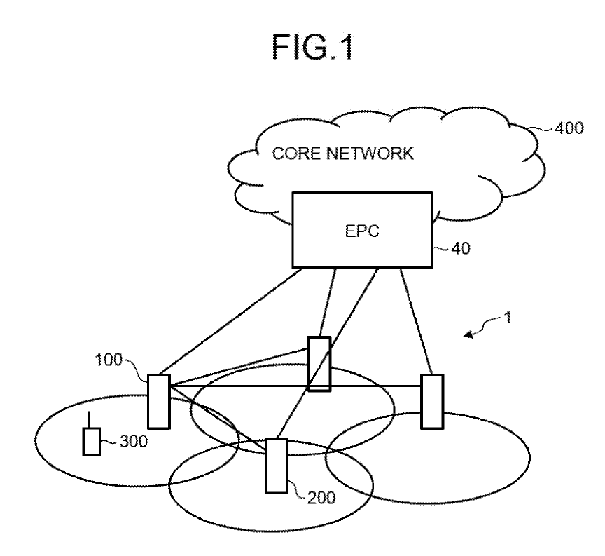

FIG. 1 is a network configuration diagram of a wireless communication system. As illustrated in FIG. 1, this wireless communication system 1 includes a plurality of base station apparatuses including base station apparatuses 100 and 200, a wireless mobile terminal device 300, and a core network 400.

The core network 400 includes an evolved packet core (EPC) 40. The EPC 40 serves as an interface with the base station apparatuses including the base station apparatuses 100 and 200 in the core network 400. The EPC 40 includes, for example, a mobility management entity (MME), a serving gateway (S-GW), a packet data network gateway (P-GW), and a policy and charging rules function (PCRF).

Each of the base station apparatuses including the base station apparatuses 100 and 200 communicates with the wireless mobile terminal device 300 located within a cell formed by the base station apparatus. Each of the base station apparatuses including the base station apparatuses 100 and 200 performs communication using a station-to-station interface that connects one base station apparatus to another. Although FIG. 1 illustrates, as an example, only paths extending from the base station apparatus 100 to each of the different base station apparatuses, each of the base station apparatuses has paths connecting to other base station apparatuses, in reality. In addition, the base station apparatuses including the base station apparatuses 100 and 200 perform communication with the core network 400 via the EPC 40.

The wireless mobile terminal device 300 connects with, out of the base station apparatuses including the base station apparatuses 100 and 200, a base station apparatus having a cell in which the wireless mobile terminal device 300 is located. The wireless mobile terminal device 300 performs communication with another wireless mobile terminal device 300 via the base station apparatus with which the wireless mobile terminal device 300 is connected and the core network 400.

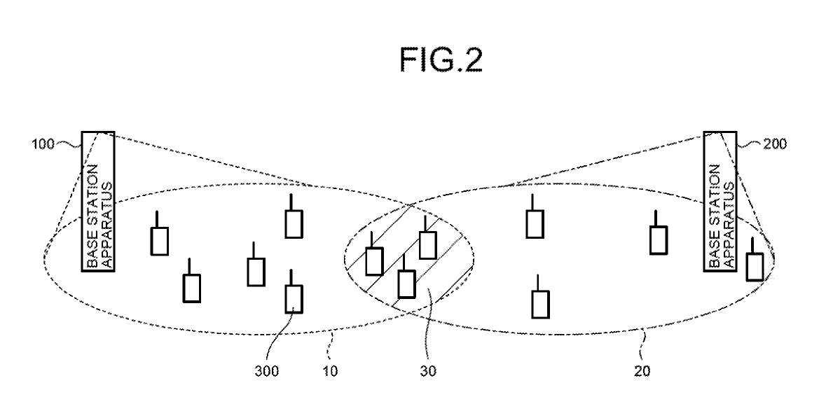

FIG. 2 is a diagram for illustrating overlapping of cells between base station apparatuses. FIG. 2 illustrates, as an example, cells of the base station apparatuses 100 and 200.

The base station apparatus 100 has a cell 10. The base station apparatus 200 has a cell 20. The cell 10 and the cell 20 have an overlapping area 30 in which the cell 10 and the cell 20 overlap each other.

Under the foregoing condition, the wireless mobile terminal device 300 that connects with the base station apparatus 100 or the base station apparatus 200 is located in an area of the cell 10 excluding the overlapping area 30, an area of the cell 20 excluding the overlapping area 30, or the overlapping area 30. The wireless mobile terminal device 300 located in the area of the cell 10 excluding the overlapping area 30 can connect with the base station apparatus 100 only. The wireless mobile terminal device 300 located in the area of the cell 20 excluding the overlapping area 30 can connect with the base station apparatus 200 only. In contrast, the wireless mobile terminal device 300 located in the overlapping area 30 connects with either one of the base station apparatuses 100 and 200.

The wireless mobile terminal device 300 located in the overlapping area 30, when connected, for example, with the base station apparatus 100, is subject to interference by signals from the base station apparatus 200, thus exhibiting degraded communication quality. Thus, preferably, the number of wireless mobile terminal devices 300 located in the overlapping area 30 is fewer for greater reduction in degradation of the communication quality caused by signal interference. Thus, to reduce degradation of the communication quality caused by signal interference, the base station apparatuses 100 and 200 according to the first embodiment change ranges of the cells 10 and 20. The following details the base station apparatuses 100 and 200.

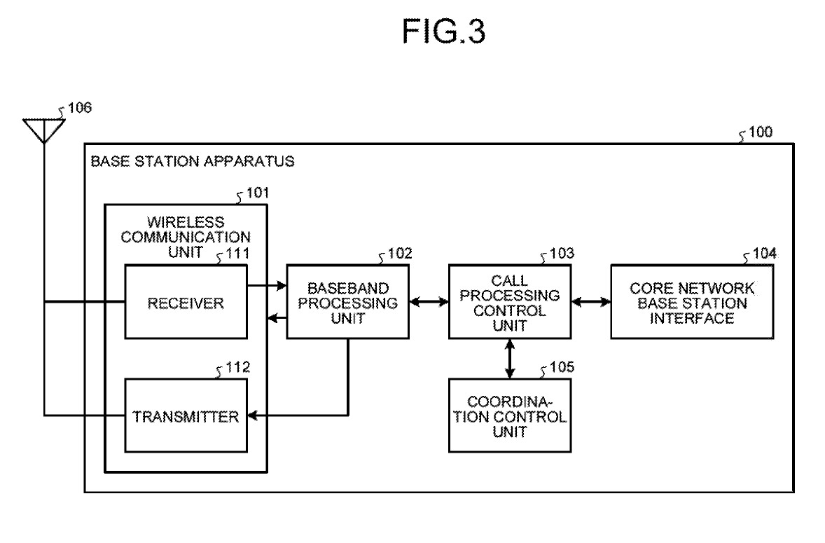

FIG. 3 is a block diagram of the base station apparatus. The following exemplarily describes the base station apparatus 100. The base station apparatus 200 has a configuration similar to a configuration of the base station apparatus 100. It is to be noted that the base station apparatus may be a leading base station that plays a leading role in changing the cell range or a cooperating base station that receives an instruction from the leading base station to change the cell range and a coordination control unit 105 performs processing differently between the leading base station and the cooperating base station. The following description assumes that the base station apparatus 100 is the leading base station and the base station apparatus 200 is the cooperating base station. In reality, however, the base station apparatus 100 and the base station apparatus 200 each have both of the functions performed by the leading base station and the cooperating base station. The base station apparatus 100 is an exemplary “first base station apparatus” and the cell 10 is an exemplary “first cell”. Similarly, the base station apparatus 200 is an exemplary “second base station apparatus” and the cell 20 is an exemplary “second cell”.

The base station apparatus 100 includes a wireless communication unit 101, a baseband processing unit 102, a call processing control unit 103, a core network base station interface 104, the coordination control unit 105, and an antenna 106.

The wireless communication unit 101 serves as an interface in wireless communication with the wireless mobile terminal device 300. The wireless communication unit 101 includes a receiver 111 and a transmitter 112.

The receiver 111 receives via the antenna 106 a wireless signal transmitted from the wireless mobile terminal device 300. The receiver 111 outputs the received signal to the baseband processing unit 102.

The transmitter 112 receives from the baseband processing unit 102 an input of a signal at a radio frequency. The transmitter 112 transmits the wireless signal to the wireless mobile terminal device 300 at a destination via the antenna 106.

When the cell range for the cell 10 is to be changed, the wireless communication unit 101 receives from the baseband processing unit 102 an input of antenna directivity, and a unit and a condition for use in transmission power control that can achieve a target cell range. Using the received information, the wireless communication unit 101 controls the antenna directivity and the transmission power. The foregoing procedures enable the cell range for the cell 10 to be changed to the target cell range established by the coordination control unit 105 described later.

The baseband processing unit 102 receives an input of the signal having the wireless signal frequency from the receiver 111. The baseband processing unit 102 performs demodulation to thereby change the frequency of the received signal and generates a baseband signal. Additionally, the baseband processing unit 102 performs decoding of the generated baseband signal. The baseband processing unit 102 thereafter outputs the decoded baseband signal to the call processing control unit 103.

The baseband processing unit 102 also receives an input of the baseband signal from the call processing control unit 103. The baseband processing unit 102 then performs encoding of the received baseband signal. Additionally, the baseband processing unit 102 modulates the encoded baseband signal to thereby change the frequency and generates a wireless signal. The baseband processing unit 102 thereafter outputs the generated wireless signal to the transmitter 112.

When the cell range is to be changed, the baseband processing unit 102 receives from the call processing control unit 103 an instruction to change the cell range for the cell 10 to a target cell range. The baseband processing unit 102 determines the antenna directivity, and the unit and the condition for use in transmission power control such that the cell 10 exhibits the target cell range. The baseband processing unit 102 then notifies the wireless communication unit 101 of the determined antenna directivity, and the unit and the condition for use in transmission power control.

The call processing control unit 103 controls general call processing relating to wireless communication and voice communication, such as control of the wireless mobile terminal device 300, communication resources, and the like, using a preset call setting. For example, the call processing control unit 103 manages connections between the base station apparatus 100 and the wireless mobile terminal device 300 including a handover of the wireless mobile terminal device 300. Additionally, the call processing control unit 103 terminates a layer (L) 3 message including a measurement report.

The call processing control unit 103 receives signals from the baseband processing unit 102. The call processing control unit 103 outputs to the core network base station interface 104 signals to be transmitted to the core network 400 and other base station apparatuses. Additionally, the call processing control unit 103 receives signals from the core network 400 or other base station apparatuses. The call processing control unit 103 outputs to the baseband processing unit 102 signals to be transmitted to the wireless mobile terminal device 300.

In addition, the call processing control unit 103 receives from the coordination control unit 105 an input of information on a target cell range for the cell 10. The call processing control unit 103 instructs the baseband processing unit 102 to change the cell range for the cell 10 to the target cell range.

The core network base station interface 104 serves as an interface for the base station apparatus 100 to communicate with the core network 400.

The coordination control unit 105 controls processing performed for determining the change of the cell range. More specifically, the coordination control unit 105 in the base station apparatus 100 that serves as the leading base station changes the cell range for the cells 10 and 20 in a stagewise fashion and, on the basis of a condition in which the wireless mobile terminal device 300 receives a signal in the overlapping area 30 at each of the different stages of the cell range, fixes an optimum cell range.

It is, however, noted that, in reality, the coordination control unit 105 of the base station apparatus 200 that serves as the cooperating base station changes the cell range for the cell 20 in accordance with an instruction from the coordination control unit 105 in the base station apparatus 100.

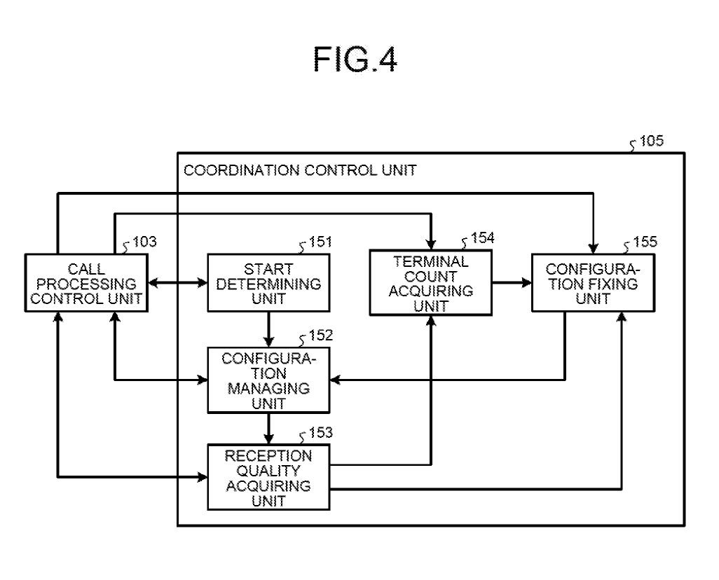

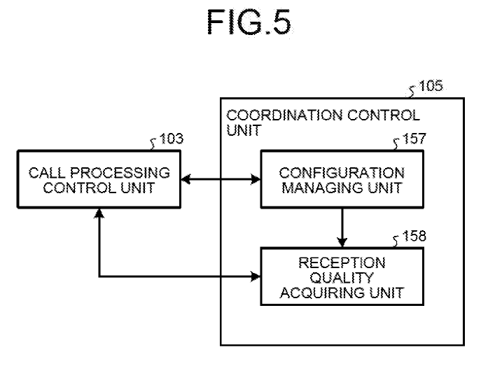

The following details the coordination control unit 105 in the base station apparatus 100 as the leading base station and the coordination control unit 105 of the base station apparatus 200 as the cooperating base station. FIG. 4 is a block diagram illustrating details of the coordination control unit in the leading base station. FIG. 5 is a block diagram illustrating details of the coordination control unit in the cooperating base station.

As illustrated in FIG. 4, the coordination control unit 105 in the base station apparatus 100 as the leading base station includes a start determining unit 151, a configuration managing unit 152, a reception quality acquiring unit 153, a terminal count acquiring unit 154, and a configuration fixing unit 155.

The start determining unit 151 has, in advance, thresholds of reception intensity from the base station apparatuses 100 and 200 for determining whether the wireless mobile terminal device 300 is located in the overlapping area 30. The start determining unit 151 further has, in advance, a start determining threshold for determining whether a change of the cell range is to be started.

The start determining unit 151 acquires from the call processing control unit 103 a measurement report from the wireless mobile terminal device 300 covered by the base station apparatus 100. The start determining unit 151 then acquires values of reception intensity from the base station apparatuses 100 and 200 registered in the acquired measurement report. The start determining unit 151 determines whether each of the acquired values of reception intensity is equal to or greater than the corresponding threshold. If each acquired value of reception intensity is equal to or greater than the threshold, the start determining unit 151 determines that the wireless mobile terminal device 300 from which the measurement report has originated is located in the overlapping area 30. For each of all wireless mobile terminal devices 300 connected with the base station apparatus 100, the start determining unit 151 determines whether the wireless mobile terminal device 300 is located in the overlapping area 30, thereby determining the number of wireless mobile terminal devices 300 that are connected with the base station apparatus 100 and located in the overlapping area 30.

The start determining unit 151, when having detected an increase in the determined number of wireless mobile terminal devices 300 that are located in the overlapping area 30, inquires of the base station apparatus 200 via the call processing control unit 103 about the number of wireless mobile terminal devices 300 that are connected with the base station apparatus 200 and located in the overlapping area 30.

When a plurality of base station apparatuses having the overlapping area 30 are involved, the start determining unit 151 selects one base station apparatus 200 subjected to the change of the cell range out of the base station apparatuses. For example, the start determining unit 151 may acquire the number of connected wireless mobile terminal devices 300 for all base station apparatuses having the overlapping area 30 with the cell 10 and select, as the base station apparatus 200 subjected to the change of the cell range, a specific base station apparatus having a minimum number of connections. Alternatively, the start determining unit 151 may have, in advance, a priority determined of the base station apparatuses having the overlapping area 30 with the cell 10 and, using the priority, select the base station apparatus 200 subjected to the change of the cell range.

The start determining unit 151 thereafter acquires via the call processing control unit 103 the number of wireless mobile terminal devices 300 that are connected with the base station apparatus 200 and located in the overlapping area 30. The start determining unit 151 then obtains a sum of the number of wireless mobile terminal devices 300 that are connected with the base station apparatus 100 and located in the overlapping area 30 and the number of wireless mobile terminal devices 300 that are connected with the base station apparatus 200 and located in the overlapping area 30. The sum represents the number of wireless mobile terminal devices 300 located in the overlapping area 30 at that time.

The start determining unit 151 determines whether the calculated sum is equal to or greater than the start determining threshold. If the sum is smaller than the start determining threshold, the start determining unit 151 determines not to execute the change of the cell range. If, in contrast, the sum is equal to or greater than the start determining threshold, the start determining unit 151 determines to execute the change of the cell range. The start determining unit 151 then instructs the configuration managing unit 152 to start the change of the cell range. It is noted that the start determining threshold is determined, for example, with reference to throughput of the base station apparatus 100. Specifically, the start determining threshold is a ratio of the number of wireless mobile terminal devices 300 located in the overlapping area 30 to the number of wireless mobile terminal devices 300 to be covered by the base station apparatus 100 that is considered to deliver reduced throughput.

The configuration managing unit 152 stores in advance a cell range for the cell 10 at each of the stages for the execution of the stagewise change of the cell range for the cell 10. The configuration managing unit 152 receives from the start determining unit 151 an instruction to execute the change of the cell range. It is here to be noted that the change of the cell range represents a change in a configuration of the cell and is an exemplary “configuration change for a wireless area”. Examples of the “configuration change for the wireless area” include, but are not limited to, changes of the cell range including expansion and shrinkage of the cell, dividing the cell and combining cells, and a change of a superimposition condition.

The configuration managing unit 152 instructs the reception quality acquiring unit 153 to measure reception quality with respect to the condition of the cell 10 before the configuration change. Additionally, the configuration managing unit 152 transmits a request for measurement of the reception quality to the base station apparatus 200 via the call processing control unit 103. The configuration managing unit 152 acquires, from among the cell ranges stored therein, information on the cell range at a subsequent stage for the cell 10 before the change in a direction in which the cell 10 is expanded. The configuration managing unit 152 then instructs the call processing control unit 103 to change the cell range for the cell 10 to the acquired cell range.

Thereafter, the configuration managing unit 152 instructs the reception quality acquiring unit 153 to measure the reception quality. The configuration managing unit 152 additionally transmits a request for measurement of the reception quality to the base station apparatus 200 via the call processing control unit 103. The configuration managing unit 152 next acquires information on the cell range expanded one stage further and instructs the call processing control unit 103 to expand the cell range. The configuration managing unit 152 repeatedly requests measurement of the reception quality a predetermined number of times, while expanding the cell range for the cell 10 in a stagewise fashion.

After having repeatedly expanded the cell range for the cell 10 a predetermined number of times, the configuration managing unit 152 transmits notification of the stagewise expansion of the cell 20 to the base station apparatus 200 via the call processing control unit 103.

Thereafter, the configuration managing unit 152 receives notification of an optimal change candidate from the configuration fixing unit 155. If the optimal change candidate is the cell range for the cell 10, the configuration managing unit 152 notifies the call processing control unit 103 of information on the cell range for the cell 10 as the optimal change candidate. Additionally, the configuration managing unit 152 transmits to the base station apparatus 200 via the call processing control unit 103 notification of a change of the cell 20 to a cell range that corresponds to the cell range for the cell 10 as the optimal change candidate.

The configuration managing unit 152 has a cell range for the cell 10 corresponding to the cell range of the cell 20. If the optimal change candidate is the cell range for the cell 20, the configuration managing unit 152 acquires a cell range for the cell 10 corresponding to the cell range for the cell 20 as the optimal change candidate. The configuration managing unit 152 then notifies the call processing control unit 103 of an instruction to change the cell 10 to a cell range that corresponds to the acquired cell range for the cell 20 as the optimal change candidate. Furthermore, the configuration managing unit 152 transmits to the base station apparatus 200 via the call processing control unit 103 notification of the change of the cell range for the cell 20 to the optimal change candidate.

The configuration managing unit 152 thereafter instructs the reception quality acquiring unit 153 to measure reception quality of the wireless mobile terminal devices 300 connected with the base station apparatus 100. The configuration managing unit 152 also transmits to the base station apparatus 200 via the call processing control unit 103 measurement of reception quality of the wireless mobile terminal devices 300 connected with the base station apparatus 200. The configuration managing unit 152 is an exemplary “first configuration changing unit”.

Regardless of whether a stagewise expansion is applicable to the cell 10 or the cell 20, the reception quality acquiring unit 153 receives an instruction to measure the reception quality from the configuration managing unit 152 at timing of each stagewise expansion. The reception quality acquiring unit 153 transmits to the wireless mobile terminal devices 300 connected with the base station apparatus 100 via the call processing control unit 103 a request to measure channel state information (CSI) at each stage. At this time, the reception quality acquiring unit 153 transmits the CSI measurement request in time with the expansion of the cell range. Thereafter, the reception quality acquiring unit 153 receives via the call processing control unit 103 a CSI measurement report from the wireless mobile terminal devices 300 connected with the base station apparatus 100 at each stage. The reception quality acquiring unit 153 then acquires from the CSI measurement report the reception quality of the wireless mobile terminal devices 300 connected with the base station apparatus 100 at each stage.

It is noted that the reception quality includes, for example, reception intensity, and noise information such as reference signal received power (RSRP) and reference signal received quality (RSRQ). The reception quality further includes reception quality of signals from the base station apparatus 200 in the wireless mobile terminal devices 300 connected with the base station apparatus 100.

The reception quality acquiring unit 153 outputs the reception quality of the wireless mobile terminal devices 300 connected with the base station apparatus 100 at each stage to the terminal count acquiring unit 154.

The terminal count acquiring unit 154 receives from the reception quality acquiring unit 153 an input of the reception quality of the wireless mobile terminal devices 300 connected with the base station apparatus 100 at each stage. Additionally, the terminal count acquiring unit 154 acquires from the call processing control unit 103 information on the reception quality of the wireless mobile terminal devices 300 connected with the base station apparatus 200 at each stage. This information is transmitted from the base station apparatus 200. This reception quality includes also reception quality of signals from the base station apparatus 100 in the wireless mobile terminal devices 300 connected with the base station apparatus 200.

The terminal count acquiring unit 154 obtains, for example, the number of wireless mobile terminal devices 300 connected with the base station apparatus 100 and the number of wireless mobile terminal devices 300 connected with the base station apparatus 200 using the reception intensity at each of the wireless mobile terminal devices 300 at each stage. Additionally, the terminal count acquiring unit 154 acquires, for each stage, the reception intensity of signals from the base station apparatus 200 in the wireless mobile terminal devices 300 connected with the base station apparatus 100 and the reception intensity of signals from the base station apparatus 100 in the wireless mobile terminal devices 300 connected with the base station apparatus 200.

The terminal count acquiring unit 154 has a grouping threshold that serves as a threshold of reception intensity for grouping the wireless mobile terminal devices 300. In the first embodiment, the terminal count acquiring unit 154 has a first grouping threshold and a second grouping threshold that is greater than the first grouping threshold. It is further noted that, in the first embodiment, the wireless mobile terminal devices 300 are divided into three groups according to the reception intensity; however, the number of groups is illustrative only and not limiting.

The terminal count acquiring unit 154 divides, for expansion of the cell 10, the wireless mobile terminal devices 300 connected with the base station apparatus 200 into the following three groups using reception quality of signals from the base station apparatus 100. The three groups are a group having reception quality lower than the first grouping threshold, a group having reception quality equal to or higher than the first grouping threshold and smaller than the second grouping threshold, and a group having reception quality equal to or higher than the second grouping threshold. In the following, the group having reception quality of signals from the base station apparatus 100 lower than the first grouping threshold is referred to as a “small interference group”, the group having reception quality of signals from the base station apparatus 100 equal to or higher than the first grouping threshold and lower than the second grouping threshold is referred to as a “medium interference group”, and the group having reception quality of signals from the base station apparatus 100 equal to or higher than the second grouping threshold is referred to as a “large interference group”.

The terminal count acquiring unit 154 acquires the number of wireless mobile terminal devices 300 that belong to each of the small interference group, the medium interference group, and the large interference group at each stage of expansion of the cell 10. The terminal count acquiring unit 154 then notifies the configuration fixing unit 155 of the acquired number of wireless mobile terminal devices 300 that belong to each of the small interference group, the medium interference group, and the large interference group.

The terminal count acquiring unit 154 divides, for expansion of the cell 20, the wireless mobile terminal devices 300 connected with the base station apparatus 100 into the above-described three groups using reception quality of signals from the base station apparatus 200.

The terminal count acquiring unit 154 acquires the number of wireless mobile terminal devices 300 that belong to each of the small interference group, the medium interference group, and the large interference group at each stage of expansion of the cell 20. The terminal count acquiring unit 154 then notifies the configuration fixing unit 155 of the acquired number of wireless mobile terminal devices 300 that belong to each of the small interference group, the medium interference group, and the large interference group.

The configuration fixing unit 155 receives from the terminal count acquiring unit 154 the notification of the number of wireless mobile terminal devices 300 that belong to each of the small interference group, the medium interference group, and the large interference group in each of the expansion of the cell 10 and the expansion of the cell 20. It is here noted that belonging to the large interference group is an exemplary “first predetermined condition” and an exemplary “second predetermined condition”.

The configuration fixing unit 155 obtains a difference in the number of wireless mobile terminal devices 300 belonging to the large interference group between different stages for the expansion of the cell 10. The configuration fixing unit 155 then selects cell ranges for the cell 10 each resulting in a difference in the number of wireless mobile terminal devices 300 belonging to the large interference group from a corresponding number in the cell range at one stage before being equal to or smaller than a predetermined value. The configuration fixing unit 155 determines the selected cell ranges for the cell 10 as change candidates on the expansion side of the cell 10.

Additionally, the configuration fixing unit 155 obtains a difference in the number of wireless mobile terminal devices 300 belonging to the large interference group between different stages for the expansion of the cell 20. The configuration fixing unit 155 then selects cell ranges for the cell 20 each resulting in a difference in the number of wireless mobile terminal devices 300 belonging to the large interference group from a corresponding number in the cell range at one stage before being equal to or smaller than a predetermined value. The configuration fixing unit 155 determines the selected cell ranges for the cell 20 as change candidates on the expansion side of the cell 20.

The configuration fixing unit 155 next selects one change candidate as the optimal change candidate from among the change candidates on the expansion side of the cell 10 and the change candidates on the expansion side of the cell 20. Specifically, if only one change candidate is available among the change candidates on the expansion side of the cell 10 and the change candidates on the expansion side of the cell 20, the configuration fixing unit 155 selects that particular change candidate as the optimal change candidate.

In contrast, if a plurality of change candidates are available, the configuration fixing unit 155 obtains an estimated value of the number of wireless mobile terminal devices 300 connected with each of the base station apparatus 100 and the base station apparatus 200 after the cell range has been changed for each change candidate. The configuration fixing unit 155 uses the estimated values of the number of wireless mobile terminal devices 300 thus obtained to select the optimal change candidate.

For example, the configuration fixing unit 155 sets as the optimal change candidate the change candidate that results in the numbers of wireless mobile terminal devices 300 connected with the base station apparatus 100 and the base station apparatus 200, respectively, after the cell range has been changed to each of the change candidates being close to each other. Specifically, the configuration fixing unit 155 obtains a difference between the numbers of wireless mobile terminal devices 300 connected with the base station apparatus 100 and the base station apparatus 200, respectively, after the cell range has been changed to each of the acquired change candidates and sets as the optimal change candidate the change candidate involving a minimum difference. If a plurality of applicable change candidates are involved, the configuration fixing unit 155 may select one change candidate as appropriate, or reduce the number of change candidates using another criterion, such as selecting the change candidate closer to the current cell range. Alternatively, the configuration fixing unit 155 may at this time reduce the number of change candidates using the noise information including RSRP and RSRQ among other factors of reception quality.

The configuration fixing unit 155 notifies the configuration managing unit 152 of the information on the cell range as the optimal change candidate. The configuration fixing unit 155, when having selected as the optimal change candidate a change candidate selected from among the change candidates on the expansion side of the cell 10, notifies the cell range for the cell 10 that serves as the optimal change candidate. The configuration fixing unit 155, when having selected as the optimal change candidate a change candidate selected from among the change candidates on the expansion side of the cell 20, notifies the cell range for the cell 20 that serves as the optimal change candidate.

After having notified the optimal change candidate, the configuration fixing unit 155 acquires from the reception quality acquiring unit 153 measurements of the reception quality of the wireless mobile terminal devices 300 connected with the base station apparatus 100. The configuration fixing unit 155 also receives from the base station apparatus 200 via the call processing control unit 103 measurements of the reception quality of the wireless mobile terminal devices 300 connected with the base station apparatus 200. On the basis of the acquired measurements of the reception quality, the configuration fixing unit 155 determines the change of the cell range.

The following describes, with reference to FIG. 5, the coordination control unit 105 of the base station apparatus 200 as the cooperating base station. As illustrated in FIG. 5, the coordination control unit 105 of the base station apparatus 200 includes a configuration managing unit 157 and a reception quality acquiring unit 158.

For expansion of the cell 20, the configuration managing unit 157 receives from the call processing control unit 103 of the base station apparatus 200 the notification of the stagewise expansion of the cell 20 transmitted from the configuration managing unit 152 of the base station apparatus 100. The configuration managing unit 157 repeatedly performs the stagewise expansion of the cell range for the cell 20 a predetermined number of times. Additionally, the configuration managing unit 157 instructs the reception quality acquiring unit 158 to acquire reception quality.

The configuration managing unit 157 stores in advance the cell range of the cell 20 corresponding to the cell range of the cell 10. When a change candidate on the expansion side of the cell 10 has been selected as the optimal change candidate, the configuration managing unit 157 receives from the call processing control unit 103 notification of a change of the cell 20 to the cell range corresponding to the cell range of the cell 10 as the optimal change candidate. The configuration managing unit 157 then acquires the cell range of the cell 20 corresponding to the cell range of the cell 10 involved in the notified change. The configuration managing unit 157 thereafter instructs the call processing control unit 103 to execute a change to the acquired cell range.

When a change candidate on the expansion side of the cell 20 has been selected as the optimal change candidate, the configuration managing unit 157 receives from the call processing control unit 103 notification of a change to the cell range of the cell 20 as the optimal change candidate. The configuration managing unit 157 then instructs the call processing control unit 103 to change the cell 20 to the specified cell range.

Upon receipt of the instruction to change the cell 20 from the configuration managing unit 157, the call processing control unit 103, the baseband processing unit 102, and the wireless communication unit 101 perform operations identical to the operations performed for the change of the cell 10 of the base station apparatus 100, to thereby change the cell 20. The foregoing operations cause the cell range for the cell 20 to be changed to the cell range specified by the coordination control unit 105. The configuration managing unit 157 is an exemplary “second configuration changing unit”.

The reception quality acquiring unit 158 receives, for expansion of the cell 10, from the call processing control unit 103 an instruction to acquire the reception quality issued by the configuration managing unit 152 of the base station apparatus 100. For expansion of the cell 20, the reception quality acquiring unit 158 receives the instruction to acquire the reception quality from the configuration managing unit 157.

The reception quality acquiring unit 158, having received the notification for acquisition of the reception quality, transmits via the call processing control unit 103 CSI measurement requests to all wireless mobile terminal devices 300 connected with the base station apparatus 200 in time with the expansion of the cell 10 or the cell 20. Thereafter, the reception quality acquiring unit 158 acquires from the call processing control unit 103 a CSI measurement report transmitted by each of the wireless mobile terminal devices 300. Using the CSI measurement report, the reception quality acquiring unit 158 acquires information on the reception quality at each of the wireless mobile terminal devices 300.

After having repeatedly acquired the reception quality a predetermined number of times, the reception quality acquiring unit 158 terminates the acquisition of the reception quality. The reception quality acquiring unit 158 transmits to the base station apparatus 100 via the call processing control unit 103 the acquired information on the reception quality at each of all wireless mobile terminal devices 300 connected with the base station apparatus 200 at each of the different stages.

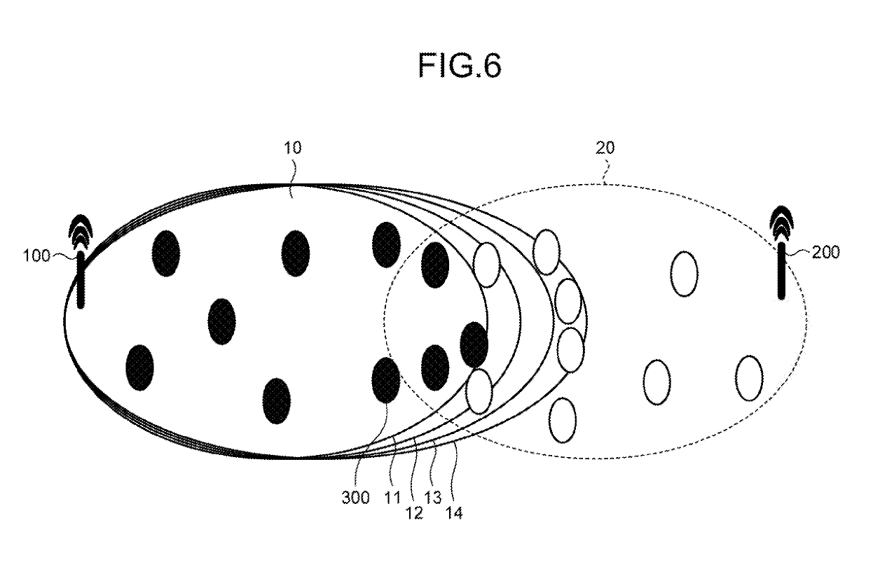

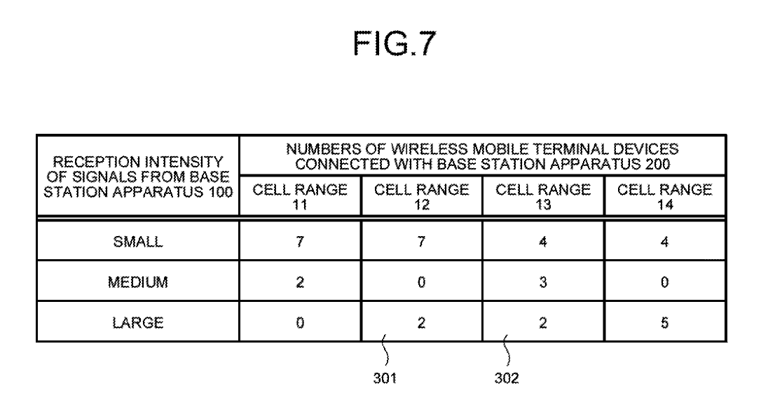

The following further details, with reference to FIGS. 6 and 7, the determination of the change candidate through the stagewise expansion of the cell 10. FIG. 6 is a diagram for illustrating the expansion of the cell of the leading base station. FIG. 7 is a table that depicts measurements taken when the cell of the leading base station is expanded.

As illustrated in FIG. 6, a total of 19 wireless mobile terminal devices 300 are located in the cell 10 and the cell 20 and, before the expansion of the cell, ten wireless mobile terminal devices 300 out of the total 19 are connected with the base station apparatus 100 and nine wireless mobile terminal devices 300 are connected with the base station apparatus 200. In FIG. 6, black ellipses denote the wireless mobile terminal devices 300 connected with the base station apparatus 100 and blank ellipses denote the wireless mobile terminal devices 300 connected with the base station apparatus 200. Additionally, in FIG. 6, a cell range 11 represents the cell range of the cell 10 before the change and cell ranges 12 to 14 each represent the cell range of the cell 10 expanded in the stagewise fashion.

When the cell range of the cell 10 before the cell change is the cell range 11, the terminal count acquiring unit 154 acquires information on the reception quality of the wireless mobile terminal devices 300 connected with the base station apparatus 100. The terminal count acquiring unit 154 also acquires information on the reception quality of the wireless mobile terminal devices 300 connected with the base station apparatus 200. The terminal count acquiring unit 154 then acquires reception intensity of signals from the base station apparatus 100 in the wireless mobile terminal devices 300 connected with the base station apparatus 200. The terminal count acquiring unit 154 next uses the reception intensity to divide the wireless mobile terminal devices 300 connected with the base station apparatus 200 into groups.

The configuration managing unit 152 of the base station apparatus 100, upon receipt of the notification of the start of the change of the cell range, expands the cell 10 one stage to change the cell range for the cell 10 to the cell range 12. For the cell range 12, the terminal count acquiring unit 154 acquires the reception intensity of signals from the base station apparatus 100 in the wireless mobile terminal devices 300 connected with the base station apparatus 200. The terminal count acquiring unit 154 divides the wireless mobile terminal devices 300 connected with the base station apparatus 200 into groups.

The configuration managing unit 152 expands the cell 10 further one stage to change the cell range for the cell 10 to the cell range 13. For the cell range 13, the terminal count acquiring unit 154 acquires the reception intensity of signals from the base station apparatus 100 in the wireless mobile terminal devices 300 connected with the base station apparatus 200. The terminal count acquiring unit 154 divides the wireless mobile terminal devices 300 connected with the base station apparatus 200 into groups.

The configuration managing unit 152 expands the cell 10 further one stage to change the cell range for the cell 10 to the cell range 14. For the cell range 14, the terminal count acquiring unit 154 acquires the reception intensity of signals from the base station apparatus 100 in the wireless mobile terminal devices 300 connected with the base station apparatus 200. The terminal count acquiring unit 154 divides the wireless mobile terminal devices 300 connected with the base station apparatus 200 into groups.

The configuration fixing unit 155 acquires from the terminal count acquiring unit 154 the number of wireless mobile terminal devices 300 connected with the base station apparatus 200 and belonging to each group at each stage of the cell ranges 11 to 14 for the cell 10. The table depicted in FIG. 7 summarizes the numbers of wireless mobile terminal devices 300 belonging to the different groups at different stages, acquired by the configuration fixing unit 155.

In this case, the configuration fixing unit 155 sets as the change candidate the cell range after the expansion when there is no change in the number of wireless mobile terminal devices 300 belonging to the large interference group before and after the expansion of the cell range. In this case, as illustrated in FIG. 7, the number of wireless mobile terminal devices 300 belonging to the large interference group for the cell range 12 is two as indicated by a column 301 and the number of wireless mobile terminal devices 300 belonging to the large interference group for the cell range 13 is two as indicated by a column 302. Specifically, the number of wireless mobile terminal devices 300 belonging to the large interference group remains the same between the cell range 12 and the cell range 13. Thus, the configuration fixing unit 155 sets the cell range 13 as the change candidate on the expansion side of the cell 10. The change candidate when the cell 10 is the cell range 13 is referred to as a “first change candidate”.

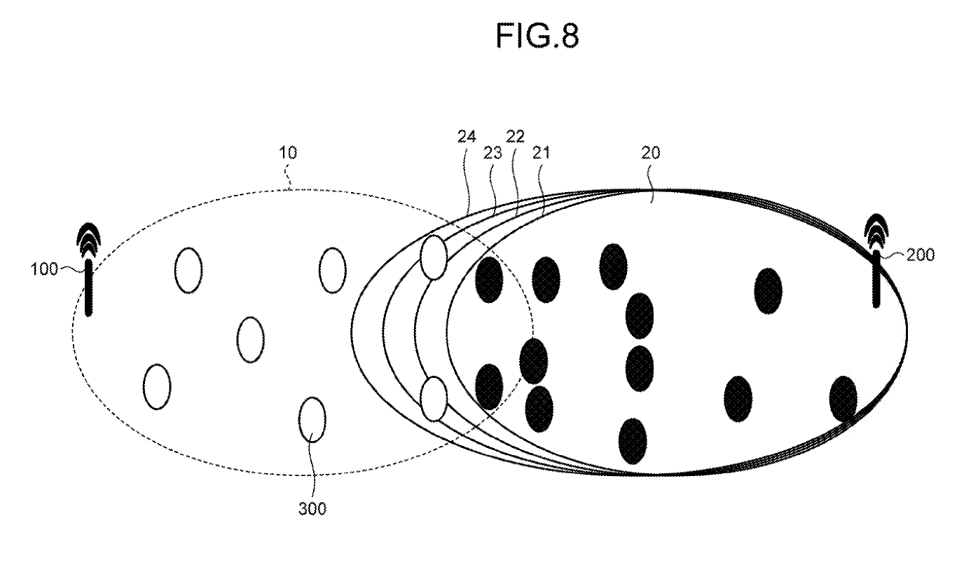

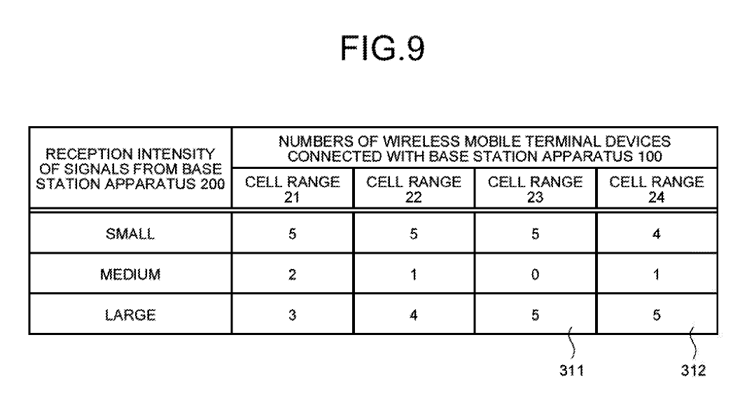

The following details, with reference to FIGS. 8 and 9, the determination of the change candidate through the stagewise expansion of the cell 20. FIG. 8 is a diagram for illustrating the expansion of the cell of the cooperating base station. FIG. 9 is a table that depicts measurements taken when the cell of the cooperating base station is expanded.

The configuration managing unit 152 of the base station apparatus 100 initiates the expansion of the cell 20 after having expanded the cell 10 the predetermined number of times. In this case, the configuration managing unit 152 transmits an instruction for a stagewise expansion of the cell 20 to the base station apparatus 200.

When the cell range of the cell 20 before the cell change is a cell range 21, the terminal count acquiring unit 154 acquires reception intensity of signals from the base station apparatus 200 in the wireless mobile terminal devices 300 connected with the base station apparatus 100. The terminal count acquiring unit 154 divides the wireless mobile terminal devices 300 connected with the base station apparatus 100 into groups.

The configuration managing unit 157 of the base station apparatus 200 expands the cell 20 one stage to change the cell range for the cell 20 to a cell range 22. For the cell range 22, the terminal count acquiring unit 154 acquires the reception intensity of the signals from the base station apparatus 200 in the wireless mobile terminal devices 300 connected with the base station apparatus 100. The terminal count acquiring unit 154 then divides the wireless mobile terminal devices 300 connected with the base station apparatus 100 into groups.

The configuration managing unit 157 expands the cell 20 further one stage to change the cell range for the cell 20 to a cell range 23. For the cell range 23, the terminal count acquiring unit 154 acquires the reception intensity of the signals from the base station apparatus 200 in the wireless mobile terminal devices 300 connected with the base station apparatus 100. The terminal count acquiring unit 154 then divides the wireless mobile terminal devices 300 connected with the base station apparatus 100 into groups.

The configuration managing unit 157 expands the cell 20 further one stage to change the cell range for the cell 20 to a cell range 24. For the cell range 24, the terminal count acquiring unit 154 acquires the reception intensity of the signals from the base station apparatus 200 in the wireless mobile terminal devices 300 connected with the base station apparatus 100. The terminal count acquiring unit 154 then divides the wireless mobile terminal devices 300 connected with the base station apparatus 100 into groups.

The configuration fixing unit 155 acquires from the terminal count acquiring unit 154 the number of wireless mobile terminal devices 300 connected with the base station apparatus 100 and belonging to each group at each stage of the cell ranges 21 to 24 for the cell 20. The table depicted in FIG. 9 summarizes the numbers of wireless mobile terminal devices 300 belonging to the different groups at different stages, acquired by the configuration fixing unit 155.

In this case, as illustrated in FIG. 9, the number of wireless mobile terminal devices 300 belonging to the large interference group for the cell range 23 is five as indicated by a column 311 and the number of wireless mobile terminal devices 300 belonging to the large interference group for the cell range 24 is five as indicated by a column 312. Specifically, the number of wireless mobile terminal devices 300 belonging to the large interference group remains the same between the cell range 23 and the cell range 24. Thus, the configuration fixing unit 155 sets the cell range 24 as the change candidate on the expansion side of the cell 20. The change candidate when the cell 20 is the cell range 24 is referred to as a “second change candidate”.

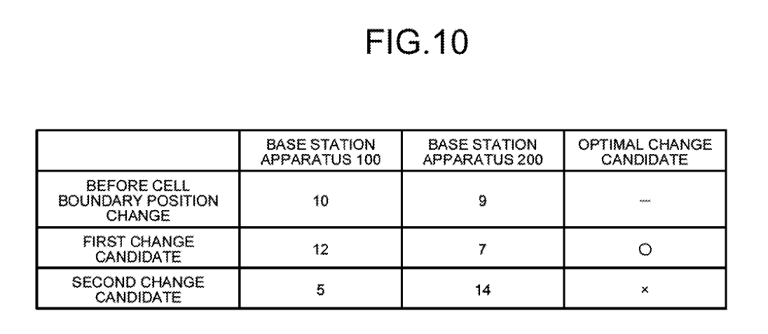

FIG. 10 is a table that depicts the number of wireless mobile terminal devices connected with each base station apparatus for each change candidate. The configuration fixing unit 155 estimates the numbers of wireless mobile terminal devices 300 connected with the base station apparatus 100 and the base station apparatus 200 when the cell 10 is the cell range 13 and the cell 20 is a cell range corresponding to the cell range 13. The configuration fixing unit 155 further estimates the numbers of wireless mobile terminal devices 300 connected with the base station apparatus 100 and the base station apparatus 200 when the cell 20 is the cell range 24 and the cell 10 is a cell range corresponding to the cell range 24.

In this case, for the first change candidate, the configuration fixing unit 155 estimates that the number of wireless mobile terminal devices 300 connected with the base station apparatus 100 is 12 and the number of wireless mobile terminal devices 300 connected with the base station apparatus 200 is 7 as illustrated in FIG. 10. For the second change candidate, the configuration fixing unit 155 estimates that the number of wireless mobile terminal devices 300 connected with the base station apparatus 100 is 5 and the number of wireless mobile terminal devices 300 connected with the base station apparatus 200 is 14. The configuration fixing unit 155 then calculates a difference between the number of wireless mobile terminal devices 300 connected with the base station apparatus 100 and the number of wireless mobile terminal devices 300 connected with the base station apparatus 200. Specifically, when the numbers of wireless mobile terminal devices 300 connected with the base station apparatus 100 and the base station apparatus 200 are estimated as depicted in FIG. 10, the difference between the numbers of wireless mobile terminal devices 300 connected with the base station apparatus 100 and the base station apparatus 200 for the first change candidate is calculated as five by the configuration fixing unit 155. In contrast, the difference between the numbers of wireless mobile terminal devices 300 connected with the base station apparatus 100 and the base station apparatus 200 for the second change candidate is calculated as nine by the configuration fixing unit 155. Because the difference is smaller for the first change candidate than for the second change candidate, the configuration fixing unit 155 determines the first change candidate to be the optimal change candidate. In FIG. 10, the column of the change candidate selected as the optimal change candidate is marked with a circle and the column of the change candidate not selected as the optimal change candidate is marked with an x. The configuration fixing unit 155 obtains the optimal change candidate in the foregoing manner.

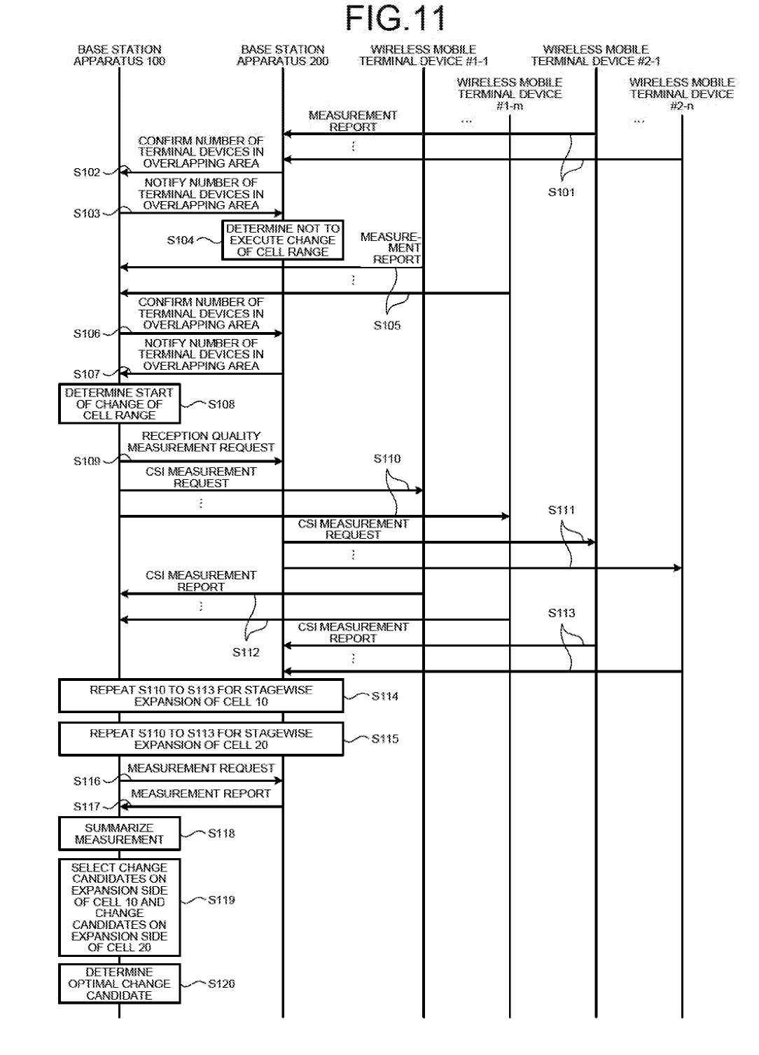

The following describes, with reference to FIG. 11, a process for selecting the optimal change candidate according to the communication system of the first embodiment. FIG. 11 is a sequence diagram illustrating the process for selecting the optimal change candidate, performed by the communication system according to the first embodiment. In FIG. 11, more time elapses toward a downward direction. FIG. 11 assumes that a determination is made not to execute a change of the cell range in the base station apparatus 200 and a determination is then made in the base station apparatus 100 to start the change of the cell range. Additionally, in FIG. 11, the wireless mobile terminal devices 300 connected with the base station apparatus 100 are denoted by wireless mobile terminal devices #1-1 to #1-m and the wireless mobile terminal devices 300 connected with the base station apparatus 200 are denoted by wireless mobile terminal devices #2-1 to #2-n. FIG. 11 further assumes that the base station apparatus 200 also has the functions as the leading base station illustrated in FIG. 4 and the base station apparatus 100 also has the functions as the cooperating base station illustrated in FIG. 5.

The start determining unit 151 of the base station apparatus 200 receives from the call processing control unit 103 the measurement reports transmitted from the wireless mobile terminal devices #2-1 to #2-n (Step S101).

If the number of wireless mobile terminal devices 300 located in the overlapping area 30 increases, the start determining unit 151 of the base station apparatus 200 transmits to the base station apparatus 100 notification of confirmation of the number of wireless mobile terminal devices 300 connected with the base station apparatus 100 and located in the overlapping area 30 (Step S102).

The coordination control unit 105 of the base station apparatus 100 obtains the number of wireless mobile terminal devices 300 connected with the base station apparatus 100 and located in the overlapping area 30 from the measurement reports. The coordination control unit 105 of the base station apparatus 100 then notifies the base station apparatus 200 of the number of wireless mobile terminal devices 300 connected with the base station apparatus 100 and located in the overlapping area 30 (Step S103).

The start determining unit 151 of the base station apparatus 200 acquires the number of wireless mobile terminal devices 300 connected with the base station apparatus 100 and located in the overlapping area 30. The start determining unit 151 of the base station apparatus 200 determines whether the change of the cell range is to be started depending on whether the sum of the number of wireless mobile terminal devices 300 connected with the base station apparatus 100 and located in the overlapping area 30 and the number of wireless mobile terminal devices 300 connected with the base station apparatus 200 and located in the overlapping area 30 is equal to or greater than the start determining threshold. The following assumes that the number of wireless mobile terminal devices 300 located in the overlapping area 30 is smaller than the start determining threshold. The start determining unit 151 of the base station apparatus 200 determines not to execute the change of the cell range (Step S104).

The start determining unit 151 of the base station apparatus 100 receives from the call processing control unit 103 the measurement reports transmitted from the wireless mobile terminal devices #1-1 to #1-m (Step S105).

If the number of wireless mobile terminal devices 300 located in the overlapping area 30 increases, the start determining unit 151 of the base station apparatus 100 transmits to the base station apparatus 200 notification of confirmation of the number of wireless mobile terminal devices 300 connected with the base station apparatus 200 and located in the overlapping area 30 (Step S106).

The coordination control unit 105 of the base station apparatus 200 obtains the number of wireless mobile terminal devices 300 connected with the base station apparatus 200 and located in the overlapping area 30 from the measurement reports. The coordination control unit 105 of the base station apparatus 200 then notifies the base station apparatus 100 of the number of wireless mobile terminal devices 300 connected with the base station apparatus 200 and located in the overlapping area 30 (Step S107).

The start determining unit 151 of the base station apparatus 100 acquires the number of wireless mobile terminal devices 300 connected with the base station apparatus 200 and located in the overlapping area 30. The start determining unit 151 of the base station apparatus 100 determines whether the change of the cell range is to be started depending on whether the sum of the number of wireless mobile terminal devices 300 connected with the base station apparatus 100 and located in the overlapping area 30 and the number of wireless mobile terminal devices 300 connected with the base station apparatus 200 and located in the overlapping area 30 is equal to or greater than the start determining threshold. The following assumes that the number of wireless mobile terminal devices 300 located in the overlapping area 30 is equal to or greater than the start determining threshold. The start determining unit 151 of the base station apparatus 100 determines to start the change of the cell range (Step S108). The start determining unit 151 notifies the configuration managing unit 152 of the start of the change of the cell range.

The configuration managing unit 152 of the base station apparatus 100 instructs the reception quality acquiring unit 153 of the base station apparatus 100 to measure the reception quality. Additionally, the configuration managing unit 152 transmits a reception quality measurement request to the reception quality acquiring unit 158 of the base station apparatus 200 (Step S109).

The reception quality acquiring unit 153 of the base station apparatus 100 transmits the CSI measurement requests to the wireless mobile terminal devices #1-1 to #1-m (Step S110).

Additionally, the reception quality acquiring unit 158 of the base station apparatus 200 transmits the CSI measurement requests to the wireless mobile terminal devices #2-1 to #2-n (Step S111).

The wireless mobile terminal devices #1-1 to #1-m transmit the CSI measurement reports to the base station apparatus 100 (Step S112). The reception quality acquiring unit 153 of the base station apparatus 100 acquires the CSI measurement reports of the wireless mobile terminal devices #1-1 to #1-m from the call processing control unit 103 of the base station apparatus 100.

The wireless mobile terminal devices #2-1 to #2-n transmit the CSI measurement reports to the base station apparatus 200 (Step S113). The reception quality acquiring unit 158 of the base station apparatus 200 acquires the CSI measurement reports of the wireless mobile terminal devices #2-1 to #2-n from the call processing control unit 103 of the base station apparatus 200.

The configuration managing unit 152 of the base station apparatus 100 expands the cell 10 in the stagewise fashion. For each expansion of the cell 10 by one stage, the base station apparatus 100 and the base station apparatus 200 repeat Steps S110 to S113 (Step S114). When the cell 10 has been expanded the predetermined number of times and the expansion of the cell 10 is completed, the configuration managing unit 157 of the base station apparatus 200 expands the cell 20 in the stagewise fashion. For each expansion of the cell 20 by one stage, the base station apparatus 100 and the base station apparatus 200 repeat Steps S110 to S113 (Step S115).

When the cell 20 has been expanded the predetermined number of times and the expansion of the cell 20 is completed, the terminal count acquiring unit 154 of the base station apparatus 100 transmits a measurement request to the reception quality acquiring unit 158 of the base station apparatus 200 (Step S116).

Upon receipt of the measurement request, the reception quality acquiring unit 158 of the base station apparatus 200 makes a measurement report by transmitting to the terminal count acquiring unit 154 of the base station apparatus 100 information on the reception quality at the wireless mobile terminal devices #2-1 to #2-n at each stage of acquisition (Step S117).

The terminal count acquiring unit 154 of the base station apparatus 100 acquires from the reception quality acquiring unit 153 information on the reception quality at the wireless mobile terminal devices #1-1 to #1-m at each stage. Additionally, the terminal count acquiring unit 154 acquires the information on the reception quality at the wireless mobile terminal devices #2-1 to #2-n at each stage, transmitted from the reception quality acquiring unit 158 of the base station apparatus 200. The terminal count acquiring unit 154 summarizes the information on the reception quality at the wireless mobile terminal devices #1-1 to #1-m and the wireless mobile terminal devices #2-1 to #2-n at each stage, representing the measurement (Step S118). Furthermore, the terminal count acquiring unit 154 divides the wireless mobile terminal devices #1-1 to #1-m and the wireless mobile terminal devices #2-1 to #2-n into groups using the grouping thresholds, thereby acquiring the number of terminal devices belonging to each group. The terminal count acquiring unit 154 thereafter outputs to the configuration fixing unit 155 information on the grouped wireless mobile terminal devices #1-1 to #1-m and wireless mobile terminal devices #2-1 to #2-n at each stage.

The configuration fixing unit 155 of the base station apparatus 100 acquires from the terminal count acquiring unit 154 the information on the reception quality at the grouped wireless mobile terminal devices #1-1 to #1-m and wireless mobile terminal devices #2-1 to #2-n at each stage. The configuration fixing unit 155 thereafter acquires from the information on the grouped wireless mobile terminal devices #1-1 to #1-m the change candidates on the expansion side of the cell 10. The configuration fixing unit 155 also acquires from the information on the grouped wireless mobile terminal devices #2-1 to #2-n the change candidates on the expansion side of the cell 20 (Step S119).

Thereafter, the configuration fixing unit 155 fixes, from among the acquired change candidates, the change candidate involving a minimum difference before and after the change as the optimal change candidate (Step S120). The configuration fixing unit 155 thereafter outputs the fixed optimal change candidate to the configuration managing unit 152.

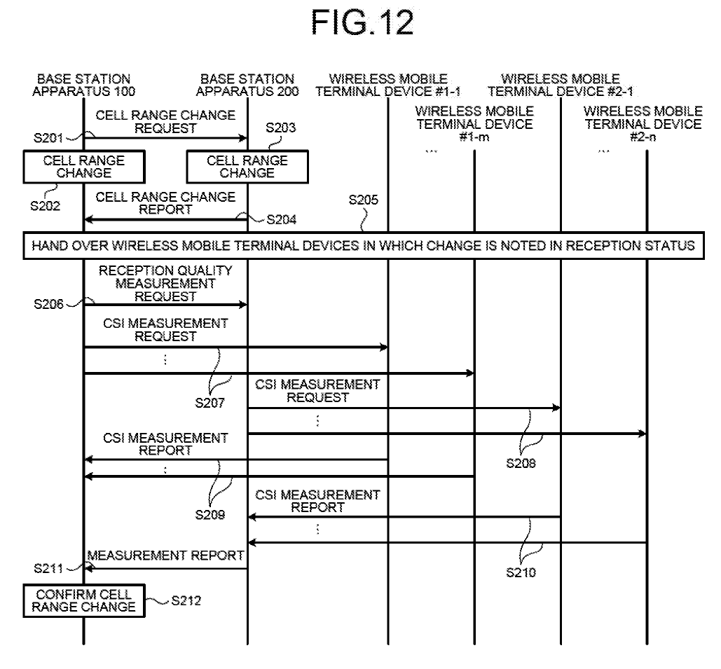

The following describes, with reference to FIG. 12, a process for changing the cell range according to the communication system of the first embodiment. FIG. 12 is a sequence diagram illustrating the process for changing the cell range, performed by the communication system according to the first embodiment. It is noted that the process depicted in FIG. 12 is performed following the process depicted in FIG. 11.

The configuration managing unit 152 of the base station apparatus 100 acquires from the configuration fixing unit 155 the information on the optimal change candidate. The configuration managing unit 152 of the base station apparatus 100 transmits to the configuration managing unit 157 of the base station apparatus 200 a request for changing the cell range for the cell 20 according to the optimal change candidate (Step S201).

The configuration managing unit 152 of the base station apparatus 100 next changes the cell range for the cell 10 according to the optimal change candidate (Step S202).

The configuration managing unit 157 of the base station apparatus 200 changes the cell range for the cell 20 according to the optimal change candidate (Step S203). The configuration managing unit 157 of the base station apparatus 200 thereafter notifies the configuration managing unit 152 of the base station apparatus 100 of a cell range change report (Step S204).

The call processing control units 103 of the base station apparatus 100 and the base station apparatus 200 hand over the wireless mobile terminal devices #1-1 to #1-m and the wireless mobile terminal devices #2-1 to #2-n in which a change is noted in the reception status before and after the change of the cell range (Step S205).

The configuration managing unit 152 of the base station apparatus 100 transmits to the reception quality acquiring unit 158 of the base station apparatus 200 a reception quality measurement request (Step S206). The configuration managing unit 152 also instructs the reception quality acquiring unit 153 to measure the reception quality.

The reception quality acquiring unit 153 of the base station apparatus 100 receives from the configuration managing unit 152 of the base station apparatus 100 the instruction to measure the reception quality. The reception quality acquiring unit 153 transmits CSI measurement requests to the wireless mobile terminal devices #1-1 to #1-m (Step S207).

The reception quality acquiring unit 158 of the base station apparatus 200 receives the reception quality measurement request from the configuration managing unit 152 of the base station apparatus 100. The reception quality acquiring unit 158 transmits CSI measurement requests to the wireless mobile terminal devices #2-1 to #2-n (Step S208).

The wireless mobile terminal devices #1-1 to #1-m transmit the CSI measurement reports to the base station apparatus 100 (Step S209). The reception quality acquiring unit 153 acquires from the call processing control unit 103 of the base station apparatus 100 the measurement reports of the wireless mobile terminal devices #1-1 to #1-m.

The wireless mobile terminal devices #2-1 to #2-n transmit the CSI measurement reports to the base station apparatus 200 (Step S210). The reception quality acquiring unit 158 acquires from the call processing control unit 103 of the base station apparatus 200 the CSI measurement reports of the wireless mobile terminal devices #2-1 to #2-n. Thereafter, the reception quality acquiring unit 158 transmits to the configuration fixing unit 155 of the base station apparatus 100 the information on the reception quality at the wireless mobile terminal devices #2-1 to #2-n, to thereby make a measurement report (Step S211).

The configuration fixing unit 155 of the base station apparatus 100 acquires from the reception quality acquiring unit 153 the measurements of the reception quality at the wireless mobile terminal devices #1-1 to #1-m. The configuration fixing unit 155 receives from the reception quality acquiring unit 158 of the base station apparatus 200 the measurements of the reception quality at the wireless mobile terminal devices #2-1 to #2-n. From the measurement of the reception quality at each of the wireless mobile terminal devices #1-1 to #1-m and the wireless mobile terminal devices #2-1 to #2-n, the configuration fixing unit 155 determines the change of the cell range (Step S212) and terminates the process for changing the cell range.

The configuration change process, while being performed only once in the first embodiment, may be performed a plurality of times. For example, the configuration fixing unit 155, after having determined the change of the cell range, acquires from the measurement of the reception quality the number of wireless mobile terminal devices 300 in the overlapping area 30 and determines whether the change of the cell range has reduced the number of wireless mobile terminal devices 300 in the overlapping area 30. If the number of wireless mobile terminal devices 300 in the overlapping area 30 has not been reduced, the configuration fixing unit 155 determines that a radio wave status has not been improved.

If the radio wave status has not been improved, the configuration fixing unit 155 may cause the reception quality to be measured again to determine the optimal change candidate and repeatedly execute a change of the cell range according to the optimal change candidate. Alternatively, if the radio wave status has not been improved, the configuration fixing unit 155 may select as the optimal change candidate another candidate from among the change candidates before the determination of the optimal change candidate and repeatedly execute a change of the cell range according to the reselected optimal change candidate.

As described above, the base station apparatus according to the first embodiment operates as the leading base station when the number of wireless mobile terminal devices in the overlapping area increases. The leading base station identifies areas that involve a smaller number of wireless mobile terminal devices when the cell of the leading base station is expanded and the cell of the cooperating base station is expanded to thereby extract the change candidates for the cell. Additionally, the leading base station selects from among the extracted change candidates to fix a change candidate for the cell as the optimal change candidate such that the number of wireless mobile terminal devices covered by the leading base station is equal, as close as possible, to the number of wireless mobile terminal devices covered by the cooperating base station and changes the cells of the leading base station and the cooperating base station according to the fixed optimal change candidate. By operatively associating a plurality of adjacent base station apparatuses with each other as described above, the cell boundary can be fixed appropriately, so that a cell configuration can be formed optimally for the disposition of the wireless mobile terminal devices within the wireless communication system. Furthermore, the number of wireless mobile terminal devices located in the overlapping area between the leading base station and the cooperating base station can be reduced, so that throughput of the entire wireless communication system can be improved.

Through the reduction in the number of wireless mobile terminal devices located in the overlapping area, the wireless communication system according to the first embodiment can considerably reduce control data volume with respect to, for example, a measure against interference caused by coordination between base station apparatuses, such as coordinate multi-point (CoMP). It is to be noted that CoMP includes, for example, coordinated scheduling/coordinated beam forming (CS/CB), dynamic point selection/dynamic point blanking (DPS/DPB), and joint transmission (JT). Additionally, the wireless communication system according to the first embodiment can reduce the number of occurrences of delay time, so that a needed level of processing time accuracy can be guaranteed.

The first embodiment has been described for a case in which two base station apparatuses are operatively associated. Nonetheless, three or more base station apparatuses may be operatively associated with each other through the similar processing to thereby reduce the number of wireless mobile terminal devices located in areas that overlap these base station apparatuses.

First Modification

The following describes a base station apparatus 100 according to a first modification of the first embodiment. The base station apparatus 100 according to the first modification determines whether to start the change of the cell range also when the number of wireless mobile terminal devices 300 connected with the host apparatus increases.

A start determining unit 151 stores in advance, as a leading-side start determining threshold, the number of wireless mobile terminal devices 300 connected with the base station apparatus 100 and considered to be responsible for reduced system throughput. Additionally, the start determining unit 151 stores, as a cooperating-side start determining threshold, the number of wireless mobile terminal devices 300 connected with the base station apparatus 200 and not considered to be responsible for reduced throughput even with an increase in the number of connected wireless mobile terminal devices 300.

The start determining unit 151 receives from a call processing control unit 103 measurement reports transmitted from the wireless mobile terminal devices 300 connected with the base station apparatus 100. The start determining unit 151 determines whether the number of wireless mobile terminal devices 300 connected with the base station apparatus 100 has increased through handover to become equal to or greater than the leading-side start determining threshold.

If the number of wireless mobile terminal devices 300 connected with the base station apparatus 100 is determined to be equal to or greater than the leading-side start determining threshold, the start determining unit 151 inquires of the base station apparatus 200 about the number of wireless mobile terminal devices 300 connected with the base station apparatus 200. The start determining unit 151 thereafter acquires the number of wireless mobile terminal devices 300 connected with the base station apparatus 200 and determines whether the number is smaller than the cooperating-side start determining threshold.

If the number of wireless mobile terminal devices 300 connected with the base station apparatus 100 is determined to be smaller than the leading-side start determining threshold, the start determining unit 151 determines whether the number of wireless mobile terminal devices 300 located in the overlapping area 30 has increased to become equal to or greater than the start determination threshold.

If the number of wireless mobile terminal devices 300 is smaller than the cooperating-side start determining threshold or the number of wireless mobile terminal devices 300 located in the overlapping area 30 is equal to or greater than the start determination threshold, the start determining unit 151 inquires of the base station apparatus 200 about the number of wireless mobile terminal devices 300 located in the overlapping area 30.

The start determining unit 151 thereafter acquires the number of wireless mobile terminal devices 300 connected with the base station apparatus 200 and located in the overlapping area 30. The start determining unit 151 then determines whether the number of wireless mobile terminal devices 300 located in the overlapping area 30 is equal to or greater than the start determining threshold. If the sum is smaller than the start determining threshold, the start determining unit 151 determines not to execute the change of the cell range. The sum is the number of wireless mobile terminal devices 300. If the sum is equal to or greater than the start determining threshold, the start determining unit 151 determines to start the change of the cell range. Then, the start determining unit 151 instructs the configuration managing unit 152 to start the change of the cell range.

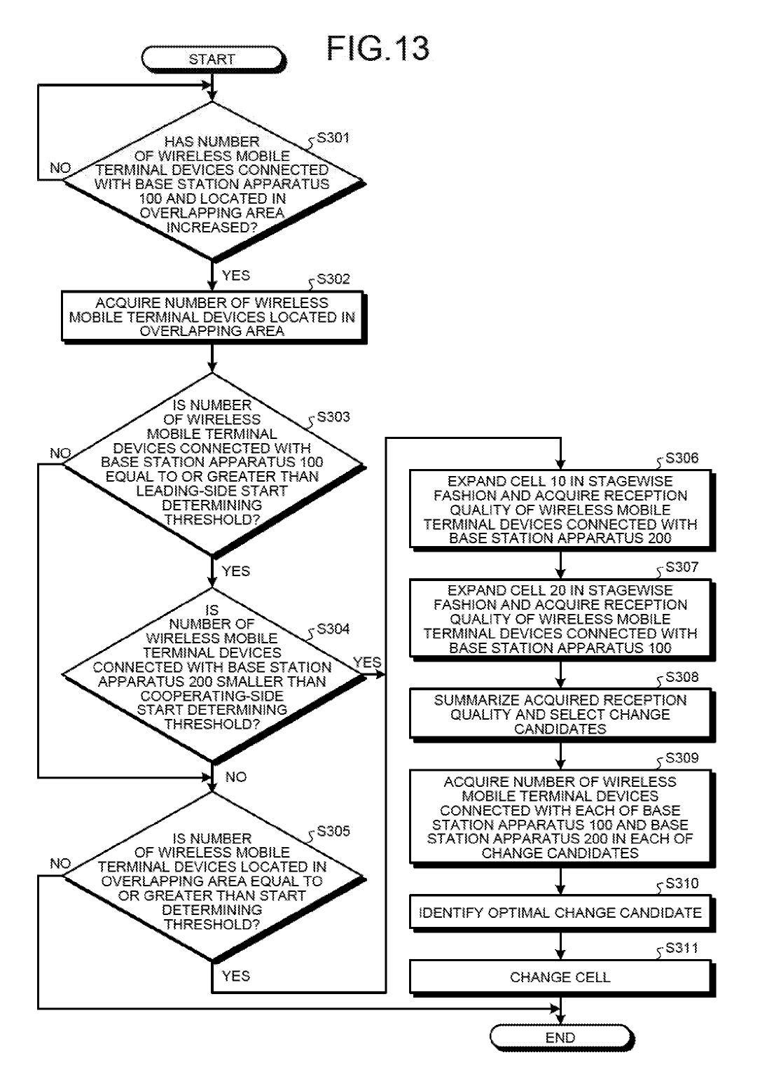

The following describes, with reference to FIG. 13, a process for changing the cell range, performed by the wireless communication system according to the first modification of the first embodiment. FIG. 13 is a flowchart that depicts the process for changing the cell range, performed by the wireless communication system according to the first modification.

The start determining unit 151 determines whether the number of wireless mobile terminal devices 300 connected with the base station apparatus 100 and located in the overlapping area 30 has increased (Step S301). If the number of wireless mobile terminal devices 300 connected with the base station apparatus 100 and located in the overlapping area 30 is not determined to have increased (No at Step S301), the start determining unit 151 repeats Step S301 and waits.

If the number of wireless mobile terminal devices 300 connected with the base station apparatus 100 and located in the overlapping area 30 is determined to have increased (Yes at Step S301), the start determining unit 151 connects to the base station apparatus 100 or the base station apparatus 200 and acquires the number of wireless mobile terminal devices 300 located in the overlapping area 30 (Step S302).

The start determining unit 151 determines whether the number of wireless mobile terminal devices 300 connected with the base station apparatus 100 is equal to or greater than the leading-side start determining threshold (Step S303). If the number of wireless mobile terminal devices 300 connected with the base station apparatus 100 is determined to be smaller than the leading-side start determining threshold (No at Step S303), the start determining unit 151 performs Step S305.

If the number of wireless mobile terminal devices 300 connected with the base station apparatus 100 is determined to be equal to or greater than the leading-side start determining threshold (Yes at Step S303), the start determining unit 151 determines whether the number of wireless mobile terminal devices 300 connected with the base station apparatus 200 is smaller than the cooperating-side start determining threshold (Step S304). If the number of wireless mobile terminal devices 300 connected with the base station apparatus 200 is determined to be smaller than the cooperating-side start determining threshold (Yes at Step S304), the start determining unit 151 performs Step S306.

If the number of wireless mobile terminal devices 300 connected with the base station apparatus 200 is determined to be equal to or greater than the cooperating-side start determining threshold (No at Step S304), the start determining unit 151 determines whether the number of wireless mobile terminal devices 300 located in the overlapping area 30 is equal to or greater than the start determining threshold (Step S305). If the number of wireless mobile terminal devices 300 located in the overlapping area 30 is determined to be smaller than the start determining threshold (No at Step S305), the start determining unit 151 terminates the process for determining the start of the cell expansion process.

If the number of wireless mobile terminal devices 300 located in the overlapping area 30 is determined to be equal to or greater than the start determining threshold (Yes at Step S305), the start determining unit 151 performs Step S306.

A configuration managing unit 152 of the base station apparatus 100 expands the cell 10 in the stagewise fashion. A reception quality acquiring unit 153 acquires information on the reception quality of each of the wireless mobile terminal devices 300 connected with the base station apparatus 200 (Step S306).

The configuration managing unit 152 of the base station apparatus 100 transmits to a configuration managing unit 157 of the base station apparatus 200 an instruction to expand the cell 20 in the stagewise fashion. The configuration managing unit 157 expands the cell 20 in the stagewise fashion. A reception quality acquiring unit 158 acquires information on the reception quality of each of the wireless mobile terminal devices 300 connected with the base station apparatus 100 (Step S307).

A terminal count acquiring unit 154 acquires from the reception quality acquiring unit 153 the information on the reception quality of each of the wireless mobile terminal devices 300 connected with the base station apparatus 100 and from the reception quality acquiring unit 158 the information on the reception quality of each of the wireless mobile terminal devices 300 connected with the base station apparatus 200. The terminal count acquiring unit 154 then summarizes the information. The terminal count acquiring unit 154 then divides the wireless mobile terminal devices 300 at each stage into groups using the information on the reception quality. A configuration fixing unit 155 acquires from the terminal count acquiring unit 154 information on the grouped wireless mobile terminal devices 300 at each stage. The configuration fixing unit 155 selects change candidates from the number of grouped wireless mobile terminal devices 300 at each stage (Step S308).

The configuration fixing unit 155 acquires the number of wireless mobile terminal devices 300 connected with each of the base station apparatus 100 and the base station apparatus 200 in each of the change candidates (Step S309).

The configuration fixing unit 155 identifies the optimal change candidate such that the number of wireless mobile terminal devices 300 connected with the base station apparatus 100 is equal, as close as possible, to the number of wireless mobile terminal devices 300 connected with the base station apparatus 200 (Step S310). The configuration fixing unit 155 outputs the information on the optimal change candidate to the configuration managing unit 152.

The configuration managing unit 152 receives from the configuration fixing unit 155 the input of the information on the optimal change candidate. The configuration managing unit 152 changes the cell 10 to the cell range corresponding to the optimal change candidate. The configuration managing unit 157 receives from the configuration managing unit 152 an instruction to change the cell 20 to a cell range corresponding to the optimal change candidate and changes the cell range for the cell 20 (Step S311).

As described above, the base station apparatus according to the first modification executes the change of the cell range even when the throughput is considered to be reduced as a result of an increase in the number of wireless mobile terminal devices connected therewith. Thus, the base station apparatus according to the first modification can reduce reduction in the throughput.

Second Modification

The following describes a base station apparatus 100 according to a second modification of the first embodiment. The base station apparatus 100 according to the second modification differs from the base station apparatus 100 according to the first embodiment in that the base station apparatus 100 in the second modification expands only the cell 20 when the number of wireless mobile terminal devices 300 connected with the host apparatus is close to a maximum permissible number.

A start determining unit 151 has in advance an expansion determining threshold for determining whether to expand the cell 10. The start determining unit 151, after having determined the start of the change of the cell range, acquires the number of wireless mobile terminal devices 300 connected with the base station apparatus 100. The start determining unit 151 then compares the number of wireless mobile terminal devices 300 connected with the base station apparatus 100 with the expansion determining threshold.

If the number of wireless mobile terminal devices 300 connected with the base station apparatus 100 is determined to be equal to or greater than the expansion determining threshold, the start determining unit 151 notifies a configuration managing unit 152 of expansion of the cell 20 only as well as the start of the change of the cell range.

In the second modification, the start determining unit 151 compares the number of wireless mobile terminal devices 300 connected with the base station apparatus 100 with the expansion determining threshold after the change of the cell range has been started. The comparison may, however, be made at any other timing. For example, the start determining unit 151 may compare the number of wireless mobile terminal devices 300 connected with the base station apparatus 100 with the expansion determining threshold when the number of wireless mobile terminal devices 300 connected with the base station apparatus 100 is determined to have increased.

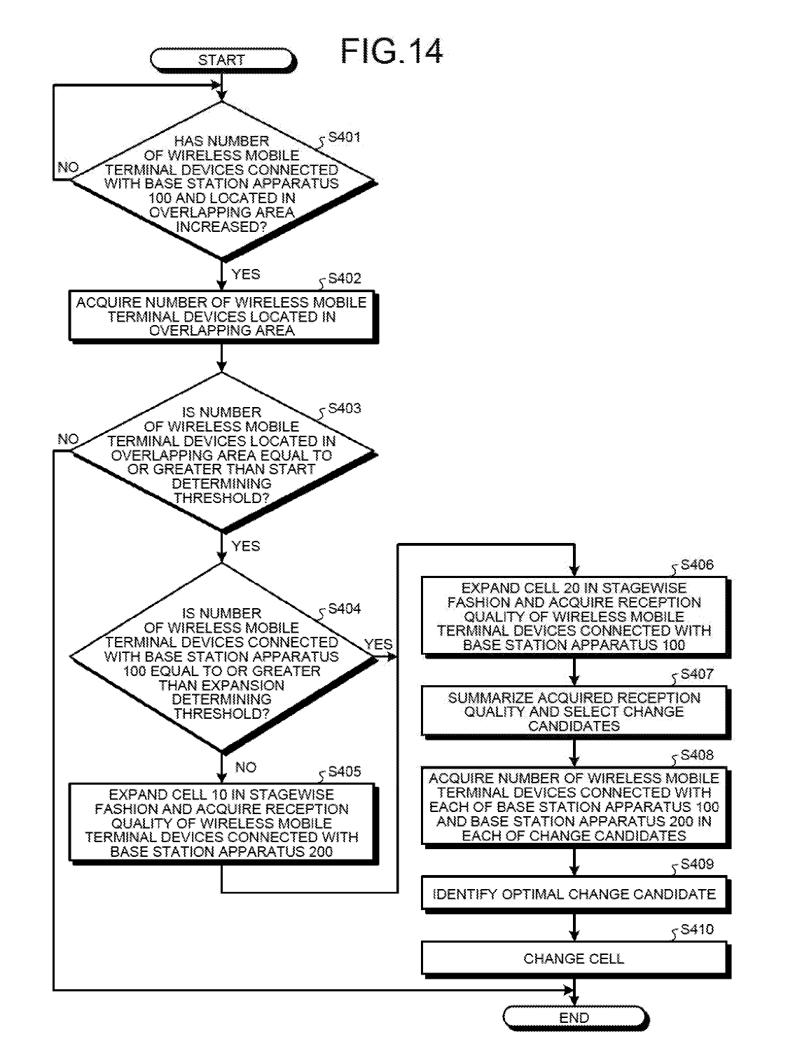

The following describes, with reference to FIG. 14, a process for changing the cell range, performed by a wireless communication system according to the second modification of the first embodiment. FIG. 14 is a flowchart that depicts the process for changing the cell range, performed by the wireless communication system according to the second modification.

The start determining unit 151 determines whether the number of wireless mobile terminal devices 300 connected with the base station apparatus 100 and located in the overlapping area 30 has increased (Step S401). If the number of wireless mobile terminal devices 300 connected with the base station apparatus 100 and located in the overlapping area 30 is not determined to have increased (No at Step S401), the start determining unit 151 repeats Step S401 and waits.

If the number of wireless mobile terminal devices 300 connected with the base station apparatus 100 and located in the overlapping area 30 is determined to have increased (Yes at Step S401), the start determining unit 151 connects to the base station apparatus 100 or the base station apparatus 200 and acquires the number of wireless mobile terminal devices 300 located in the overlapping area 30 (Step S402).

The start determining unit 151 determines whether the number of wireless mobile terminal devices 300 located in the overlapping area 30 is equal to or greater than the start determining threshold (Step S403). If the number of wireless mobile terminal devices 300 located in the overlapping area 30 is determined to be smaller than the start determining threshold (No at Step S403), the start determining unit 151 terminates the start determination in the process for changing the cell range.

If the number of wireless mobile terminal devices 300 located in the overlapping area 30 is determined to be equal to or greater than the start determining threshold (Yes at Step S403), the start determining unit 151 determines whether the number of wireless mobile terminal devices 300 connected with the base station apparatus 100 is equal to or greater than the expansion determining threshold (Step S404). If the number of wireless mobile terminal devices 300 connected with the base station apparatus 100 is determined to be equal to or greater than the expansion determining threshold (Yes at Step S404), the configuration managing unit 152 of the base station apparatus 100 performs Step S406.

If the number of wireless mobile terminal devices 300 connected with the base station apparatus 100 is determined to be smaller than the expansion determining threshold (No at Step S404), the configuration managing unit 152 of the base station apparatus 100 expands the cell 10 in the stagewise fashion. A reception quality acquiring unit 153 acquires information on the reception quality of each of the wireless mobile terminal devices 300 connected with the base station apparatus 200 (Step S405).

The configuration managing unit 152 of the base station apparatus 100 transmits to a configuration managing unit 157 of the base station apparatus 200 an instruction to expand the cell 20 in the stagewise fashion. The configuration managing unit 157 expands the cell 20 in the stagewise fashion. A reception quality acquiring unit 158 acquires information on the reception quality of each of the wireless mobile terminal devices 300 connected with the base station apparatus 100 (Step S406).

A terminal count acquiring unit 154 acquires from the reception quality acquiring unit 153 the information on the reception quality of each of the wireless mobile terminal devices 300 connected with the base station apparatus 100 and from the reception quality acquiring unit 158 the information on the reception quality of each of the wireless mobile terminal devices 300 connected with the base station apparatus 200. The terminal count acquiring unit 154 then summarizes the information. The terminal count acquiring unit 154 then divides the wireless mobile terminal devices 300 at each stage into groups using the information on the reception quality. A configuration fixing unit 155 acquires from the terminal count acquiring unit 154 information on the grouped wireless mobile terminal devices 300 at each stage. The configuration fixing unit 155 selects change candidates from the number of grouped wireless mobile terminal devices 300 at each stage (Step S407).

The configuration fixing unit 155 acquires the number of wireless mobile terminal devices 300 connected with each of the base station apparatus 100 and the base station apparatus 200 in each of the change candidates (Step S408).

The configuration fixing unit 155 identifies the optimal change candidate such that the number of wireless mobile terminal devices 300 connected with the base station apparatus 100 is equal, as close as possible, to the number of wireless mobile terminal devices 300 connected with the base station apparatus 200 (Step S409). The configuration fixing unit 155 outputs the information on the optimal change candidate to the configuration managing unit 152.

The configuration managing unit 152 of the base station apparatus 100 receives from the configuration fixing unit 155 the input of the information on the optimal change candidate. The configuration managing unit 152 changes the cell 10 to the cell range corresponding to the optimal change candidate. The configuration managing unit 157 of the base station apparatus 200 receives from the configuration managing unit 152 of the base station apparatus 100 an instruction to change the cell 20 to a cell range corresponding to the optimal change candidate and changes the cell range for the cell 20 (Step S410).

As described above, the base station apparatus according to the second modification selects the change candidate through only the expansion of the cell of the cooperating base station when the number of connected wireless mobile terminal devices is close to the maximum permissible number. This arrangement eliminates the need for selecting the change candidate as a result of an expansion of the cell of the host apparatus, thus reducing processing load.

It is to be noted that, while the second modification eliminates the selection of the change candidate involved in the expansion of the cell 10 in the leading base station, the same procedure may be applied to allow the selection of the change candidate involved in the expansion of the cell 20 in the cooperating base station to be eliminated. For example, when the number of wireless mobile terminal devices 300 connected with the base station apparatus 200 is determined to be equal to or greater than the expansion determining threshold, the start determining unit 151 may opt to eliminate the selection of the change candidate involved in the expansion of the cell 20. Alternatively, the selection of the change candidate involved in the expansion of the cell 10 in the leading base station in combination with the selection of the change candidate involved in the expansion of the cell 20 in the cooperating base station may together be eliminated.

Third Modification

The following describes a base station apparatus 100 according to a third modification of the first embodiment. The base station apparatus 100 according to the third modification differs from the base station apparatus 100 according to the first embodiment in that the base station apparatus 100 in the third modification considers equalization of the numbers of connected wireless mobile terminal devices 300 when the change candidate for the cell is to be selected.

A configuration fixing unit 155 receives from a terminal count acquiring unit 154 a notification of the number of wireless mobile terminal devices 300 belonging to each of the small interference group, the medium interference group, and the large interference group for each of the expansion of the cell 10 and the expansion of the cell 20.

The configuration fixing unit 155 also obtains an estimated value of the number of wireless mobile terminal devices 300 connected with each of the base station apparatus 100 and the base station apparatus 200 after the cell boundary position has been changed for each of the change candidates. The configuration fixing unit 155 then obtains a difference between the estimated values of the numbers of wireless mobile terminal devices 300 connected with the base station apparatus 100 and the base station apparatus 200 after the cell range has been changed to each of the change candidates.

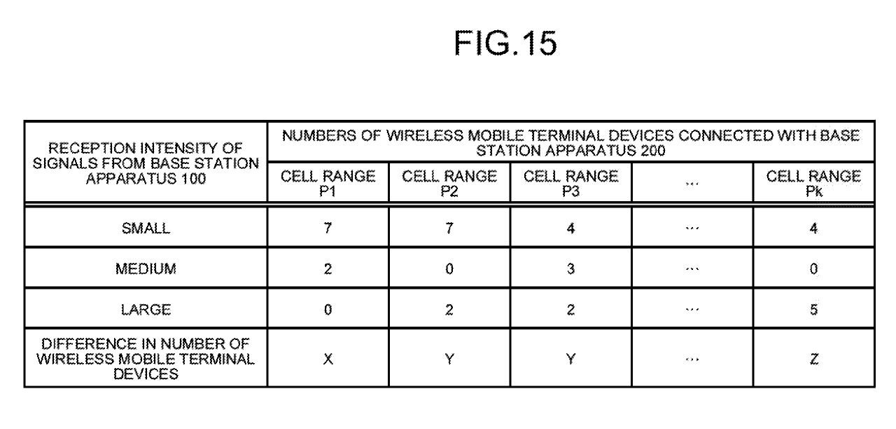

In this case, the configuration fixing unit 155 has information as depicted in FIG. 15. FIG. 15 is a table that depicts information used for selecting the change candidate in the third modification. In FIG. 15, the columns of the difference in the numbers of wireless mobile terminal devices corresponding to different cell ranges each indicate the difference in the estimated value between the number of wireless mobile terminal devices 300 connected with the base station apparatus 100 and the number of wireless mobile terminal devices 300 connected with the base station apparatus 200. While FIG. 15 depicts information applicable when the cell 10 is expanded, the configuration fixing unit 155 acquires similar information also when the cell 20 is expanded.

The configuration fixing unit 155 selects cell ranges that result in the difference in the estimated value between the number of wireless mobile terminal devices 300 connected with the base station apparatus 100 and the number of wireless mobile terminal devices 300 connected with the base station apparatus 200 being equal to or smaller than a predetermined value. The configuration fixing unit 155 further acquires, as selected from among the selected cell ranges, the cell ranges for the cell 10 resulting in a difference in the number of wireless mobile terminal devices 300 belong to the large interference group between the current cell range and the cell range one stage before being equal to or smaller than a predetermined value. The configuration fixing unit 155 sets the acquired cell ranges for the cell 10 as the change candidates on the expansion side of the cell 10.

Then, the configuration fixing unit 155 sets as the optimal change candidate a change candidate that, as selected from among the acquired change candidates, results in the numbers of wireless mobile terminal devices 300 connected with the base station apparatus 100 and the base station apparatus 200 after the change of the cell range being closest to each other.

As described above, the base station apparatus according to the third modification considers equalization of the numbers of wireless mobile terminal devices 300 connected with the different base station apparatuses when the change candidate for the cell is to be selected. This arrangement allows selection of a candidate that delivers low system throughput to be avoided, so that the numbers of connected wireless mobile terminal devices can be further equalized between different cells, in addition to reduction in the number of wireless mobile terminal devices located in the overlapping area.

### [b] Second Embodiment

The following describes a second embodiment. A base station apparatus according to the second embodiment differs from the base station apparatus in the first embodiment in that, when it is determined that no overlapping areas exist after a change of the cell range, the base station apparatus forms an overlapping area by adjusting the cell range on the shrinkage side. Thus, the following focuses on the formation of the overlapping area after the change of the cell range. The base station apparatus according to the second embodiment is also represented by the block diagrams illustrated in FIGS. 3 to 5. In the following, elements identified by the similar reference numerals to those in the first embodiment have similar functions unless otherwise noted.

A configuration fixing unit 155 of a base station apparatus 100 as the leading base station performs the following process after having confirmed the change of the cell range according to the optimal change candidates for a cell 10 and a cell 20. The configuration fixing unit 155 acquires, using information on reception quality received from a base station apparatus 200 as the cooperating base station, reception intensity of signals from the base station apparatus 100 in wireless mobile terminal devices 300 connected with the base station apparatus 200. The configuration fixing unit 155 thereby determines presence of a terminal device affected by interference from the base station apparatus 100 among the wireless mobile terminal devices 300 connected with the base station apparatus 200.

Additionally, the configuration fixing unit 155 acquires, using information on reception quality received from a reception quality acquiring unit 153 of the base station apparatus 100 as the leading base station, reception intensity of signals from the base station apparatus 200 in the wireless mobile terminal devices 300 connected with the base station apparatus 100. The configuration fixing unit 155 thereby determines presence of a terminal device affected by interference from the base station apparatus 200 among the wireless mobile terminal devices 300 connected with the base station apparatus 100.

If either a terminal device affected by interference from the base station apparatus 100 or a terminal device affected by interference from the base station apparatus 200 is present, the configuration fixing unit 155 determines that an overlapping area exists, thus terminating the process of forming the overlapping area.

If neither the terminal device affected by interference from the base station apparatus 100 nor the terminal device affected by interference from the base station apparatus 200 is present, the configuration fixing unit 155 determines that an overlapping area does not exist. In this case, the configuration fixing unit 155 determines which cell for the cell 10 or the cell 20 is shrunk in the change of the cell range.

The configuration fixing unit 155 then instructs a configuration managing unit 152 to reduce a shrinkage width of the shrunk cell, specifically, to expand the cell range for the shrunk cell. When, for example, a configuration change involving expansion of the cell 10 and shrinkage of the cell 20 is executed, the configuration fixing unit 155 outputs to the configuration managing unit 152 a cell adjustment request that instructs to expand the cell 20. When a configuration change involving expansion of the cell 20 and shrinkage of the cell 10 is executed, the configuration fixing unit 155 instructs the configuration managing unit 152 to expand the cell 10.

Thereafter, the configuration fixing unit 155 receives via a call processing control unit 103 information on the reception quality of the wireless mobile terminal devices 300 connected with the base station apparatus 200. The configuration fixing unit 155 also receives from the reception quality acquiring unit 153 information on the wireless mobile terminal devices 300 connected with the base station apparatus 100. The configuration fixing unit 155 further checks for an overlapping area on the basis of presence of a terminal device affected by interference from the base station apparatus 100 and by interference from the base station apparatus 200. If no overlapping areas are determined to exist, the configuration fixing unit 155 repeatedly expand the cell on the shrinkage side until an overlapping area is formed.

The configuration managing unit 152 receives from the configuration fixing unit 155 the instruction to expand the cell 20 or the cell 10. If an instruction to expand the cell 10 is received, the configuration managing unit 152 instructs the call processing control unit 103 to expand the cell 10. It is here noted that the configuration managing unit 152, for example, stores in advance an expansion width of the cell 10 for the formation of the overlapping area. Preferably, the expansion width of the cell 10 is smaller than the stagewise shrinkage of the cell range during the configuration change.

If an instruction to expand the cell 20 is received, the configuration managing unit 152 transmits to the base station apparatus 200 via the call processing control unit 103 the instruction to expand the cell 20.

The configuration managing unit 152, when having instructed the call processing control unit 103 of the base station apparatus 100 to expand the cell 10, thereafter receives from the call processing control unit 103 of the base station apparatus 100 a report on a cell range change. If a cell adjustment request has been transmitted to a configuration managing unit 157 of the base station apparatus 200, the configuration managing unit 152 thereafter receives from the configuration managing unit 157 a report on the cell range change.

The configuration managing unit 152, after having received the report on the cell range change, causes the reception quality acquiring unit 153 of the base station apparatus 100 and a reception quality acquiring unit 158 of the base station apparatus 200 to measure the reception quality again.

The reception quality acquiring unit 153 of the base station apparatus 100 receives from the configuration managing unit 152 the request for measurement of the reception quality after the expansion of the cell 10 or the cell 20. The reception quality acquiring unit 153 thereafter acquires information on the reception quality from the wireless mobile terminal devices 300 connected with the base station apparatus 100 and transmits the information to a configuration fixing unit 155.

When a configuration change for expanding the cell 10 and shrinking the cell 20 has been executed, the configuration managing unit 157 of the base station apparatus 200 receives from the configuration managing unit 152 of the base station apparatus 100 a request for expanding the cell 20. The configuration managing unit 157 then instructs the call processing control unit 103 of the base station apparatus 200 to expand the cell 20. It is here noted that the configuration managing unit 157, for example, stores in advance an expansion width of the cell 20 for the formation of the overlapping area. Preferably, the expansion width of the cell 20 is smaller than the stagewise shrinkage of the cell range during the configuration change.

The configuration managing unit 157 thereafter notifies the configuration managing unit 152 of the base station apparatus 100 of the report on the cell range change.

The reception quality acquiring unit 158 of the base station apparatus 200 receives from the configuration managing unit 152 of the base station apparatus 100 the request for measurement of the reception quality after the expansion of the cell 10 or the cell 20. The reception quality acquiring unit 158 thereafter acquires information on the reception quality from the wireless mobile terminal devices 300 connected with the base station apparatus 200 and transmits the information to the base station apparatus 100.

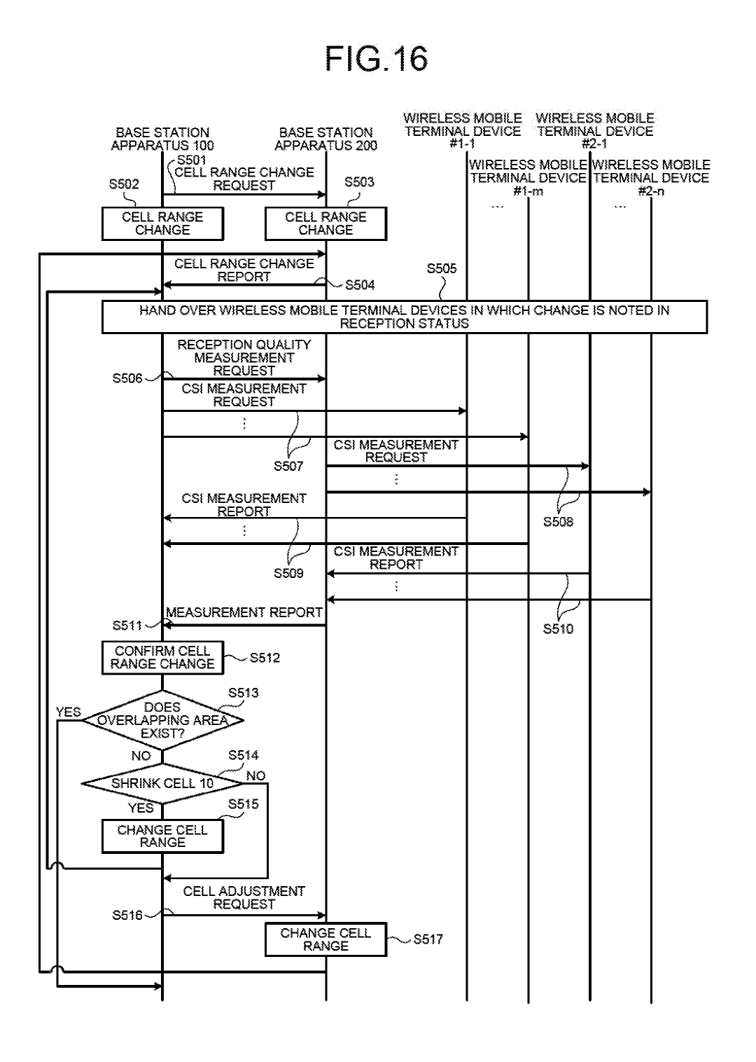

The following describes, with reference to FIG. 16, a process for forming the overlapping area, performed by a wireless communication system 1 according to the second embodiment. FIG. 16 is a sequence diagram illustrating the process for forming the overlapping area, performed by the communication system according to the second embodiment.

The configuration managing unit 152 of the base station apparatus 100 acquires from the configuration fixing unit 155 information on the optimal change candidate. The configuration managing unit 152 of the base station apparatus 100 transmits to the configuration managing unit 157 of the base station apparatus 200 a cell range change request for the cell 20 according to the optimal change candidate (Step S501).

The configuration managing unit 152 of the base station apparatus 100 next changes the cell range for the cell 10 according to the optimal change candidate (Step S502).

The configuration managing unit 157 of the base station apparatus 200 changes the cell range for the cell 20 according to the optimal change candidate (Step S503). The configuration managing unit 157 of the base station apparatus 200 thereafter notifies the configuration managing unit 152 of the base station apparatus 100 of a cell range change report (Step S504).

The call processing control units 103 of the base station apparatus 100 and the base station apparatus 200 hand over the wireless mobile terminal devices #1-1 to #1-m and the wireless mobile terminal devices #2-1 to #2-n in which a change is noted in the reception status before and after the change of the cell range (Step S505).

The configuration managing unit 152 of the base station apparatus 100 transmits to the reception quality acquiring unit 158 of the base station apparatus 200 a reception quality measurement request (Step S506). The configuration managing unit 152 also instructs the reception quality acquiring unit 153 to measure the reception quality.

The reception quality acquiring unit 153 of the base station apparatus 100 receives from the configuration managing unit 152 of the base station apparatus 100 the instruction to measure the reception quality. The reception quality acquiring unit 153 transmits CSI measurement requests to the wireless mobile terminal devices #1-1 to #1-m (Step S507).

The reception quality acquiring unit 158 of the base station apparatus 200 receives the reception quality measurement request from the configuration managing unit 152 of the base station apparatus 100. The reception quality acquiring unit 158 transmits CSI measurement requests to the wireless mobile terminal devices #2-1 to #2-n (Step S508).

Using measurement reports, the wireless mobile terminal devices #1-1 to #1-m transmit the CSI measurement reports to the base station apparatus 100 (Step S509). The reception quality acquiring unit 153 acquires from the call processing control unit 103 of the base station apparatus 100 the measurement reports of the wireless mobile terminal devices #1-1 to #1-m.

Using measurement reports, the wireless mobile terminal devices #2-1 to #2-n transmit the CSI measurement reports to the base station apparatus 200 (Step S510). The reception quality acquiring unit 158 acquires from the call processing control unit 103 of the base station apparatus 200 the measurement reports of the wireless mobile terminal devices #2-1 to #2-n. Thereafter, the reception quality acquiring unit 158 transmits to the configuration fixing unit 155 of the base station apparatus 100 the information on the reception quality at the wireless mobile terminal devices #2-1 to #2-n, to thereby make a measurement report (Step S511).

The configuration fixing unit 155 of the base station apparatus 100 acquires from the reception quality acquiring unit 153 the measurements of the reception quality at the wireless mobile terminal devices #1-1 to #1-m. The configuration fixing unit 155 receives from the reception quality acquiring unit 158 of the base station apparatus 200 the measurements of the reception quality at the wireless mobile terminal devices #2-1 to #2-n. From the measurement of the reception quality at each of the wireless mobile terminal devices #1-1 to #1-m and the wireless mobile terminal devices #2-1 to #2-n, the configuration fixing unit 155 determines the change of the cell range (Step S512).

Additionally, the configuration managing unit 152 determines whether an overlapping area exists on the basis of whether a terminal device affected by interference from the base station apparatus 100 or a terminal device affected by interference from the base station apparatus 200 is present (Step S513). If an overlapping area is determined to exist (Yes at Step S513), the configuration managing unit 152 terminates the process for changing the cell range and for forming the overlapping area.

In contrast, if an overlapping area is determined not to exist (No at Step S513), the configuration fixing unit 155 determines whether the cell 10 is on the shrinkage side (Step S514). If the cell 10 is determined to be on the shrinkage side (Yes at Step S514), the configuration fixing unit 155 instructs the configuration managing unit 152 to expand the cell 10. The configuration managing unit 152 instructs the call processing control unit 103 of the base station apparatus 100 to expand the cell 10, thereby changing the cell range for the cell 10 (Step S515). Thereafter, the base station apparatus 100 and the base station apparatus 200 perform Step S505.

In contrast, if the cell 10 is determined to be on the expansion side, specifically, the cell 20 is determined to be on the shrinkage side (No at Step S514), the configuration managing unit 152 transmits a cell adjustment request to the configuration managing unit 157 of the base station apparatus 200 (Step S516). The configuration managing unit 157 of the base station apparatus 200, having received the cell adjustment request, instructs the call processing control unit 103 of the base station apparatus 200 to expand the cell range, thereby changing the cell range for the cell 20 (Step S517). Thereafter, the base station apparatus 100 and the base station apparatus 200 perform Step S504.

As described above, if no overlapping areas exist after the change of the cell range, the base station apparatus according to the second embodiment expands the cell on the shrinkage side to form the overlapping area. This arrangement enables the cell range having an overlapping area to be reliably changed, so that a communication area involving no uncovered areas can be formed and a reliable communication service can be provided.

### Third Embodiment

The following describes a wireless communication system according to a third embodiment. The wireless communication system according to the third embodiment expands the cell range for a base station apparatus adjacent to a specific base station apparatus to thereby identify the position of a wireless mobile terminal device connected with the specific base station apparatus and, on the basis of the identified position of the wireless mobile terminal device, divides the cell. The following describes the wireless communication system according to the third embodiment.

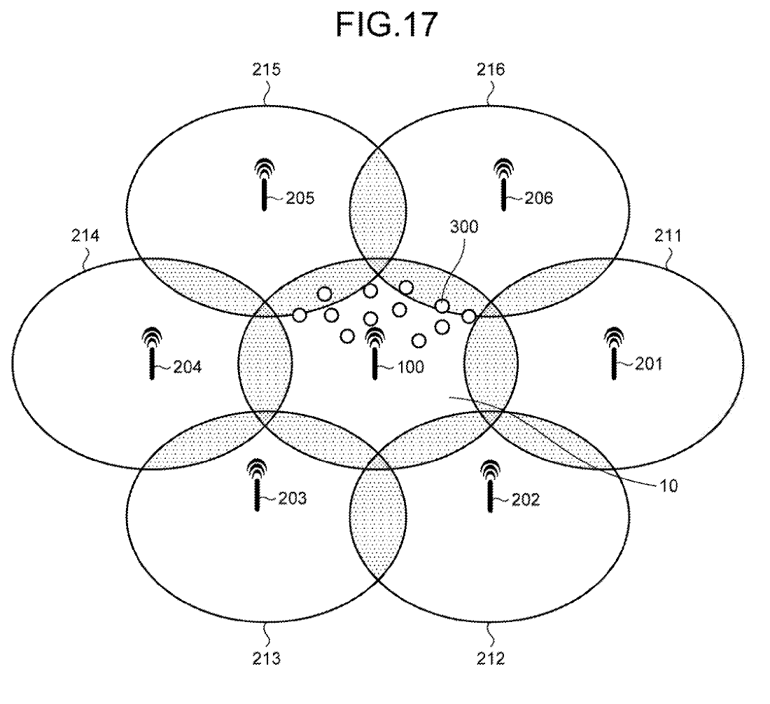

FIG. 17 is a diagram illustrating an exemplary status of cells in the wireless communication system according to the third embodiment. As illustrated in FIG. 17, the wireless communication system according to the third embodiment includes a base station apparatus 100 having a cell 10 and base station apparatuses 201 to 206 having cells 211 to 216, respectively. The cell 10 has overlapping areas with the respective cells 211 to 216. In the following, the base station apparatuses 201 to 206 and the cells 211 to 216 will be referred to generally as a “base station apparatus 200” and a “cell 210”.

The following description assumes that the base station apparatus 100 serves as the leading base station that divides the cell 10 and the base station apparatus 200 serves as the cooperating base station that operates in cooperation with the base station apparatus 100 for dividing the cell 10. The base station apparatus 100 and the base station apparatus 200 are each represented by the block diagram illustrated in FIG. 3.

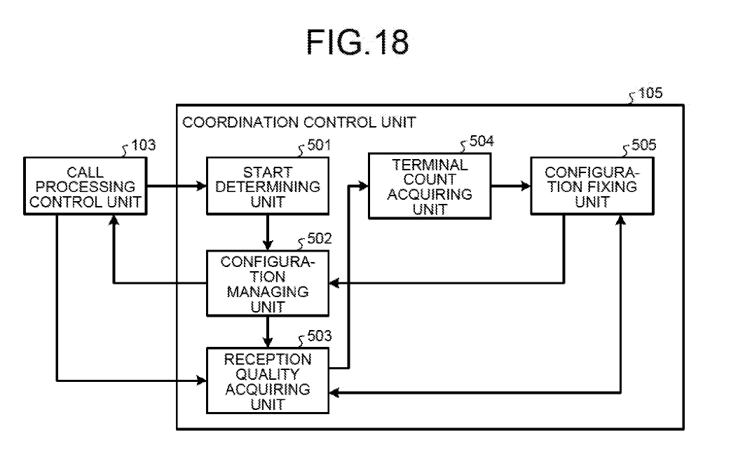

FIG. 18 is a block diagram illustrating a coordination control unit in the leading base station according to the third embodiment. This coordination control unit 105 of the base station apparatus 100 as the leading base station according to the third embodiment includes a start determining unit 501, a configuration managing unit 502, a reception quality acquiring unit 503, a terminal count acquiring unit 504, and a configuration fixing unit 505.

The start determining unit 501 stores, in advance, as a start determining threshold the number of wireless mobile terminal devices 300 that are connected with the base station apparatus 100 and that are considered to deliver reduced system throughput. The start determining unit 501 also has, in advance, reception intensity of signals from the base station apparatus 100 and the base station apparatus 200. The reception intensity of the signals are used for determining that a certain wireless mobile terminal device 300 is located in an overlapping area.

The start determining unit 501 acquires from a call processing control unit 103 measurement reports from the wireless mobile terminal devices 300 covered by the base station apparatus 100. Using the acquired measurement reports, the start determining unit 501 obtains the number of wireless mobile terminal devices 300 connected with the base station apparatus 100. The start determining unit 501 then determines whether the number of wireless mobile terminal devices 300 connected with the base station apparatus 100 is equal to or greater than the start determining threshold.

If the number of wireless mobile terminal devices 300 connected with the base station apparatus 100 is determined to be equal to or greater than the start determining threshold, the start determining unit 501 determines the start of cell division. The start determining unit 501 then instructs the configuration managing unit 502 to start the cell division.

The configuration managing unit 502 receives from the start determining unit 501 the instruction to start the cell division. The configuration managing unit 502 transmits to the base station apparatus 200 as the cooperating base station via the call processing control unit 103 an instruction to expand the cell range at predetermined timing. It is noted that the predetermined timing is previously determined, such as, for example, a predetermined period of time after the instruction to start the cell division is received from the start determining unit 501. Additionally, the configuration managing unit 502 instructs the reception quality acquiring unit 503 to acquire the reception quality from each of the wireless mobile terminal devices 300 in time with the predetermined timing. The expansion of the cell range is an exemplary “configuration change for the wireless area”.

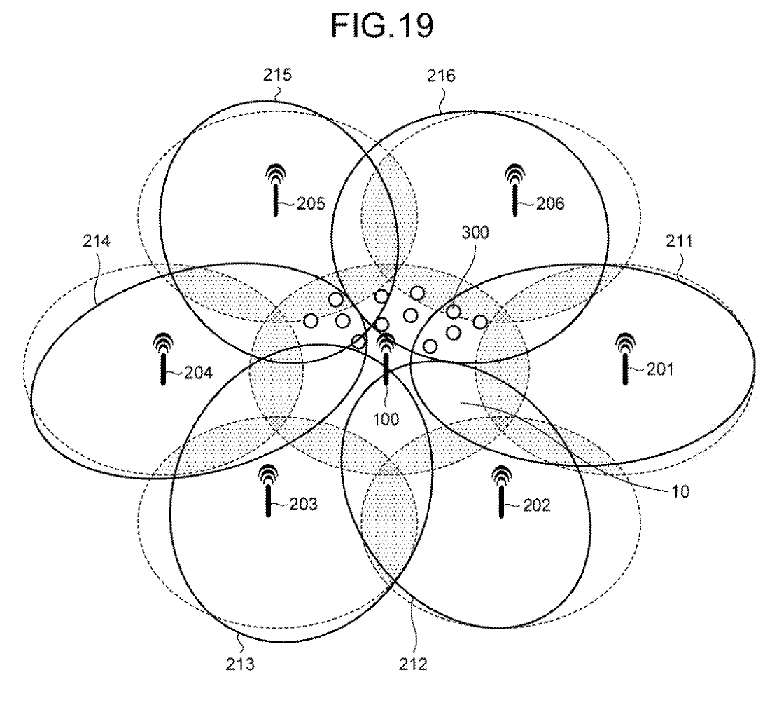

The base station apparatus 200 expands the cell 20 in accordance with the instruction from the configuration managing unit 502. The expansion of the cell 20 results in the cell 10 and the cell 210 exhibiting the condition as depicted in FIG. 19. FIG. 19 is a diagram illustrating the condition in which the cells of the cooperating base stations are expanded. Cells before the expansion are also represented by the dotted line in FIG. 19 for ease of understanding of the condition of expansion. As illustrated in FIG. 19, the cell range of the cell 210 is expanded to reach into a deep spot inside the cell 10, so that a good part of the area of the cell 10 is covered by each cell 210.

The configuration managing unit 502 thereafter receives notification of a cell configuration of the cell division fixed by the configuration fixing unit 505. The configuration managing unit 502 instructs the call processing control unit 103 in the cell division in accordance with the notified cell configuration.

The reception quality acquiring unit 503 transmits CSI measurement requests in time with the predetermined timing to the wireless mobile terminal devices 300 connected with the base station apparatus 100 via the call processing control unit 103. The reception quality acquiring unit 503 thereafter acquires via the call processing control unit 103 CSI measurement reports from the wireless mobile terminal devices 300 in time with the predetermined timing. The reception quality acquiring unit 503 outputs to the terminal count acquiring unit 504 information on the reception intensity at each of the wireless mobile terminal devices 300 included in the CSI measurement report, together with information on the base station apparatus 200 from which the signal has originated.

The reception quality acquiring unit 503 receives from the configuration fixing unit 505, after the execution of the cell division, an instruction to acquire information on the reception quality of the wireless mobile terminal devices 300 located in each cell after the division. The reception quality acquiring unit 503 transmits CSI measurement requests to the wireless mobile terminal devices 300 connected with the base station apparatus 100 after the cell division via the call processing control unit 103. The reception quality acquiring unit 503 thereafter acquires CSI measurement reports from the wireless mobile terminal devices 300 via the call processing control unit 103. The reception quality acquiring unit 503 outputs to the terminal count acquiring unit 504 the information, included in the CSI measurement reports, on the reception intensity at each of the wireless mobile terminal devices 300 located in each cell after the division.

The terminal count acquiring unit 504 has in advance a location determining threshold for determining being located in an expanded cell 210. The terminal count acquiring unit 504 receives from the reception quality acquiring unit 503 an input of information on the reception intensity at each of the wireless mobile terminal devices 300 and information on the base station apparatus 200 from which the signal has originated. The terminal count acquiring unit 504 then determines that a wireless mobile terminal device 300 having reception intensity of a signal from a given cell 210 equal to or greater than the location determining threshold is located in that particular cell 210.

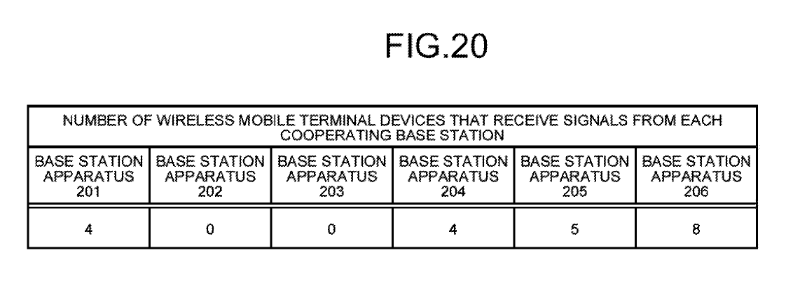

The terminal count acquiring unit 504 obtains the number of wireless mobile terminal devices 300 determined to be located in each cell 210 and acquires the number of wireless mobile terminal devices 300 for each base station apparatus 200 as illustrated in FIG. 20. It is to be noted that the term “number of wireless mobile terminal devices 300 affected by interference from the base station apparatus 200” refers to the wireless mobile terminal devices 300 located in the cell 210 of that particular base station apparatus 200. FIG. 20 is a table that depicts exemplary numbers of wireless mobile terminal devices 300 affected by interference from each cooperating base station. FIG. 20 depicts that the number of wireless mobile terminal devices 300 affected by interference from the base station apparatus 201 is four, the number of wireless mobile terminal devices 300 affected by interference from the base station apparatus 204 is four, the number of wireless mobile terminal devices 300 affected by interference from the base station apparatus 205 is five, and the number of wireless mobile terminal devices 300 affected by interference from the base station apparatus 206 is eight.

The terminal count acquiring unit 504 outputs to the configuration fixing unit 505 the number of wireless mobile terminal devices 300 affected by interference from each base station apparatus 200.

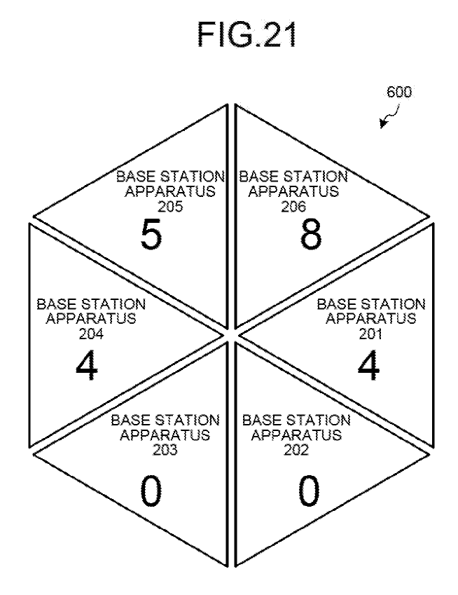

The configuration fixing unit 505 creates a distribution diagram 600 of the wireless mobile terminal devices 300 as illustrated, for example, in FIG. 21. FIG. 21 is an exemplary diagram illustrating the distribution diagram of the wireless mobile terminal devices. In the third embodiment, the six base station apparatuses of the base station apparatuses 201 to 206 each have an overlapping area with the cell 10. Thus, the distribution diagram 600 of the wireless mobile terminal devices 300 is divided into six areas as illustrated in FIG. 21. In FIG. 21, each of the base station apparatuses 201 to 206 indicated in a corresponding area of the six areas represents the base station apparatus that causes interference to the wireless mobile terminal devices 300 located therein. Additionally, the number indicated in the corresponding area represents the number of wireless mobile terminal devices 300 located in that area.

The configuration fixing unit 505 divides the current cell 10 into two sub-cells so that the numbers of wireless mobile terminal devices 300 located therein are substantially uniform. Assume, for example, that the wireless mobile terminal devices 300 are distributed as illustrated in FIG. 21. The number of wireless mobile terminal devices 300 affected by interference from the base station apparatuses 201, 202, and 206 totals 12. The number of wireless mobile terminal devices 300 affected by interference from the base station apparatuses 203, 204, and 205 totals nine. The areas represented by the distribution diagram 600 are then divided into a greater area affected by interference from the base station apparatuses 201, 202, and 206 and a greater area affected by interference from the base station apparatuses 203, 204, and 205, to thereby achieve the greatest possible uniformity in the numbers of wireless mobile terminal devices 300 located in the respective greater areas. It is here noted that some of the wireless mobile terminal devices 300 are located in areas in which a plurality of cells out of the expanded cells 211 to 216 overlap each other. As a result, when the areas are divided as illustrated in the distribution diagram of FIG. 21, a total of the numbers of wireless mobile terminal devices 300 contained in the respective areas may exceed a total number of wireless mobile terminal devices 300 connected with the base station apparatus 100.

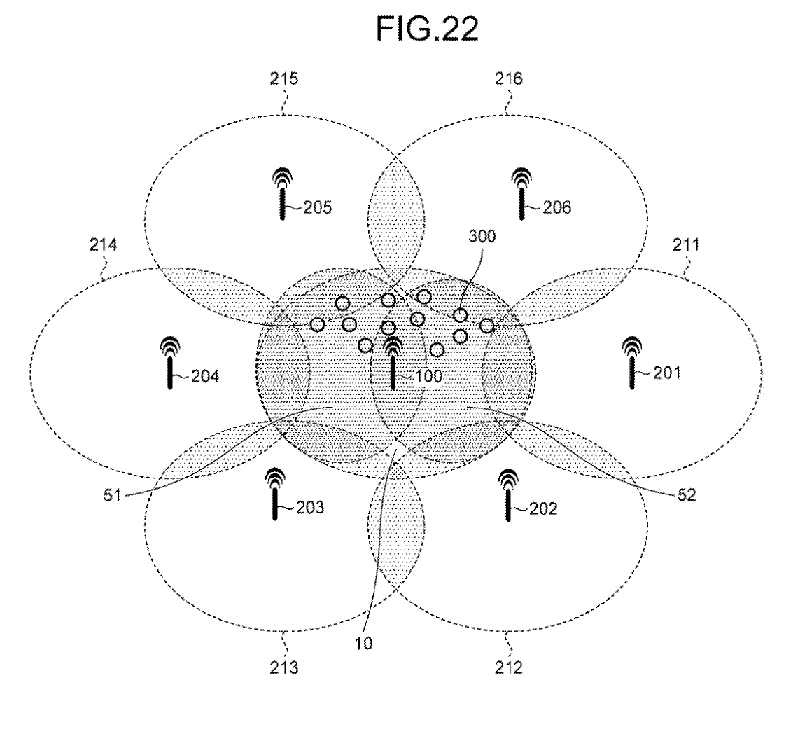

The configuration fixing unit 505 determines to divide the cell 10 into a cell that covers the areas affected by interference from the base station apparatuses 201, 202, and 206 and a cell that covers the areas affected by interference from the base station apparatuses 203, 204, and 205. Specifically, as illustrated in FIG. 22, the configuration fixing unit 505 fixes a configuration that forms a cell 51 that covers the areas affected by interference from the base station apparatuses 201, 202, and 206 and a cell 52 that covers the areas affected by interference from the base station apparatuses 203, 204, and 205. The configuration fixing unit 505 notifies the configuration managing unit 502 of the fixed cell configuration. FIG. 22 is a diagram illustrating a condition of cells after the division. Although FIG. 22 includes the cell 10 before the division for ease of understanding of the division condition, the cell 10 does not exist after the cell 51 and the cell 52 have been formed.

Thereafter, the configuration fixing unit 505 instructs the reception quality acquiring unit 503 to acquire the reception quality. Using the reception quality, received from the reception quality acquiring unit 503, of the wireless mobile terminal devices 300 connected with the base station apparatus 100 that forms the cell 51 and the cell 52, the configuration fixing unit 505 determines the numbers of wireless mobile terminal devices 300 located in the respective cells 51 and 52. If a difference between the number of wireless mobile terminal devices 300 located in the cell 51 and the number of wireless mobile terminal devices 300 located in the cell 52 is equal to or smaller than a predetermined value, at this time, the configuration fixing unit 505 determines that the wireless mobile terminal devices 300 are located uniformly in each cell.

If the wireless mobile terminal devices 300 are determined to be located uniformly in each cell, the configuration fixing unit 505 terminates the cell division process. If the wireless mobile terminal devices 300 are determined to be located not uniformly in different cells, the configuration fixing unit 505 instructs the configuration managing unit 502 to start the cell division again, to thereby cause the cell division process to be repeatedly performed for ultimate optimization of the cell division.

The coordination control unit 105 of the base station apparatus 200 receives an instruction to expand the cell range at predetermined timing transmitted by the configuration managing unit 502 of the base station apparatus 100. The coordination control unit 105 of the base station apparatus 200 temporarily expand the cell range for the cell 20 at the specified predetermined timing.

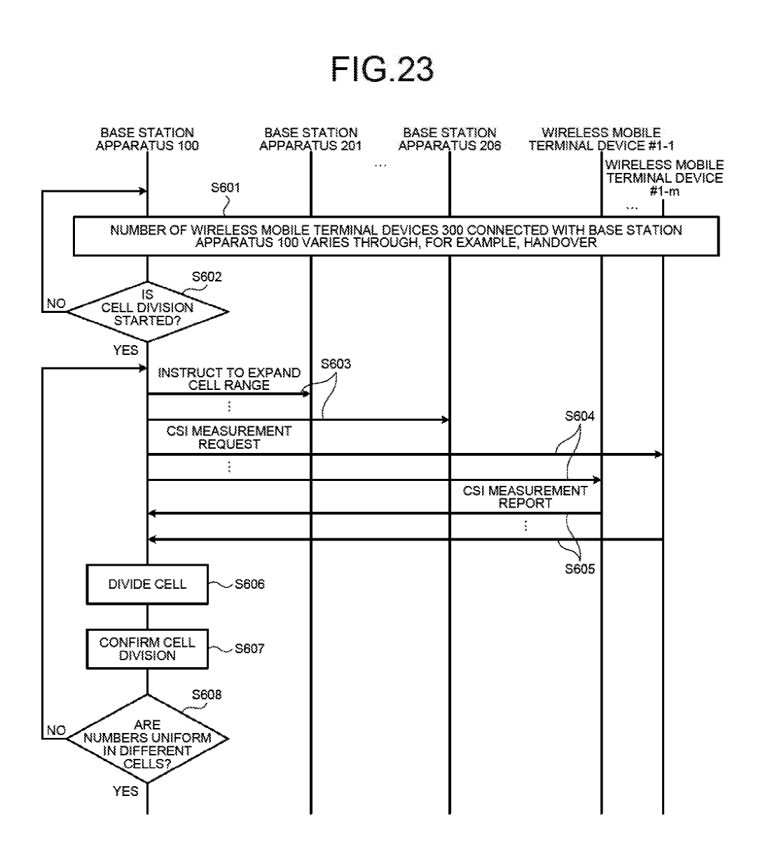

The following describes a process for dividing the cell, performed by the wireless communication system according to the third embodiment with reference to FIG. 23. FIG. 23 is a sequence diagram illustrating the cell division process performed by the wireless communication system according to the third embodiment.

The number of wireless mobile terminal devices 300 connected with the base station apparatus 100 varies through, for example, handover (Step S601).

The start determining unit 501 of the base station apparatus 100 determines whether to start the cell division depending on whether the number of wireless mobile terminal devices 300 connected with the base station apparatus 100 is equal to or greater than the start determining threshold (Step S602). If the start determining unit 501 determines not to start the cell division (No at Step S602), the wireless communication system performs Step S601.

If it has determined to start the cell division (Yes at Step S602), the start determining unit 501 of the base station apparatus 100 notifies the configuration managing unit 502 of the start of the cell division. The configuration managing unit 502 transmits to the coordination control unit 105 of each of the base station apparatuses 201 to 206 an instruction to expand the cell range for each of the cells 211 to 216 (Step S603).

The configuration managing unit 502 also instructs the reception quality acquiring unit 503 to acquire the reception quality at the predetermined timing. The reception quality acquiring unit 503 transmits CSI measurement requests in time with the predetermined timing to the wireless mobile terminal devices #1-1 to #1-m connected with the base station apparatus 100 (Step S604).

The wireless mobile terminal devices #1-1 to #1-m perform the CSI measurement at the predetermined timing. Thereafter, the wireless mobile terminal devices #1-1 to #1-m transmit CSI measurement reports to the reception quality acquiring unit 503 of the base station apparatus 100 (Step S605).

The reception quality acquiring unit 503 outputs to the terminal count acquiring unit 504 information on the reception intensity at each of the wireless mobile terminal devices 300 included in the CSI measurement report, together with information on the base station apparatus 200 from which the signal has originated. The terminal count acquiring unit 504 determines a wireless mobile terminal device 300 having reception intensity of signals from each base station apparatus 200 equal to or greater than the location determining threshold as the wireless mobile terminal device 300 affected by interference from each base station apparatus 200. Thereafter, the terminal count acquiring unit 504 outputs to the configuration fixing unit 505 the number of wireless mobile terminal devices 300 affected by interference from each base station apparatus 200. The configuration fixing unit 505 prepares the distribution diagram 600 of the wireless mobile terminal devices 300 within the cell 10. The configuration fixing unit 505 then determines to divide the cell 10 so as to eliminate non-uniformity in the numbers of located wireless mobile terminal devices 300. The configuration fixing unit 505 notifies the configuration managing unit 502 of the fixed division of the cell 10. The configuration managing unit 502 instructs the call processing control unit 103 to divide the cell 10 in accordance with the notification for the execution of the cell division (Step S606).

The configuration fixing unit 505 requests the reception quality acquiring unit 503 to acquire information on the reception quality at the wireless mobile terminal devices 300 connected with the base station apparatus 100 after the cell division. Thereafter, the configuration fixing unit 505 obtains, using the information on the reception quality acquired from the reception quality acquiring unit 503, the number of wireless mobile terminal devices 300 located in each cell after the division, thereby confirming the cell division (Step S607).

The configuration fixing unit 505 determines whether uniform numbers of wireless mobile terminal devices 300 are located in different cells after the division (Step S608). If non-uniform numbers of wireless mobile terminal devices 300 are located (No at Step S608), the base station apparatus 100 performs Step S603. If uniform numbers of wireless mobile terminal devices 300 are located (Yes at Step S608), the base station apparatus 100 terminates the cell division process.

As described above, the base station apparatus according to the third embodiment checks the distribution of the wireless mobile terminal devices located in the cell of the host apparatus using the reception quality under the condition in which the cell of the cooperating base station is expanded and divides the cell so that the wireless mobile terminal devices are uniformly distributed. This arrangement allows the cell to be automatically divided when the number of wireless mobile terminal devices within a cell increases to reduce the number of resources to be allocated to the wireless mobile terminal devices, so that a greater number of resources can be allocated to each wireless mobile terminal device.

Hardware Configuration

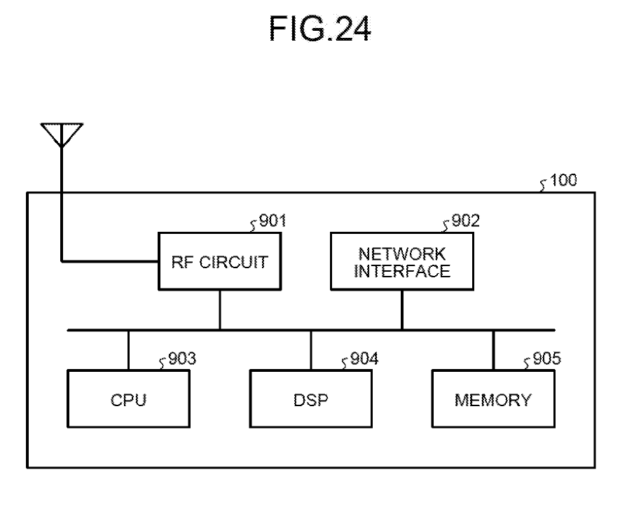

FIG. 24 is a diagram illustrating a hardware configuration of the base station apparatus. FIG. 24 illustrates the base station apparatus 100. The base station apparatus 200 has an identical configuration. As illustrated in FIG. 24, the base station apparatus 100 includes a radio frequency (RF) circuit 901, a network interface 902, a central processing unit (CPU) 903, a digital signal processor (DSP) 904, and a memory 905.

The CPU 903 is connected with the RF circuit 901, the network interface 902, the DSP 904, and the memory 905 via a bus.

The RF circuit 901 achieves the function of the wireless communication unit 101 illustrated in FIG. 3. The network interface 902 achieves the function of the core network base station interface 104 illustrated in FIG. 3.

The CPU 903 and the DSP 904 achieve the functions of the baseband processing unit 102 and the call processing control unit 103. Specifically, the DSP 904 performs wireless signal processing relating to wireless communication, including call control, incoming and outgoing control, and baseband processing.

Additionally, the CPU 903 and the memory 905 achieve the function of the coordination control unit 105 illustrated in FIG. 3. Specifically, the memory 905, for example, retains various types of programs, including programs for achieving the functions of the start determining unit 151, the configuration managing unit 152, the reception quality acquiring unit 153, the terminal count acquiring unit 154, and the configuration fixing unit 155 illustrated in FIG. 4. The CPU 903 reads and executes the various types of programs stored in the memory 905, thereby achieving the functions of the start determining unit 151, the configuration managing unit 152, the reception quality acquiring unit 153, the terminal count acquiring unit 154, and the configuration fixing unit 155.

In the base station apparatus 200, the memory 905 retains various types of programs, including programs for achieving the functions of the configuration managing unit 157 and the reception quality acquiring unit 158 illustrated in FIG. 5. The CPU 903 reads and executes the various types of programs stored in the memory 905, thereby achieving the functions of the configuration managing unit 157 and the reception quality acquiring unit 158.

In the base station apparatus 100 according to the third embodiment, the memory 905 retains various types of programs, including programs for achieving the functions of the start determining unit 501, the configuration managing unit 502, the reception quality acquiring unit 503, the terminal count acquiring unit 504, and the configuration fixing unit 505 illustrated in FIG. 18. The CPU 903 reads and executes the various types of programs stored in the memory 905, thereby achieving the functions of the start determining unit 501, the configuration managing unit 502, the reception quality acquiring unit 503, the terminal count acquiring unit 504, and the configuration fixing unit 505.

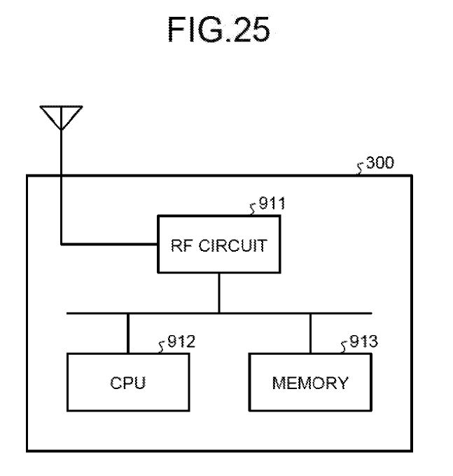

FIG. 25 is a diagram illustrating a hardware configuration of the wireless mobile terminal device. The wireless mobile terminal device 300 includes an RF circuit 911, a CPU 912, and a memory 913.

The RF circuit 911 achieves the function of transmitting and receiving wireless signals to and from the base station apparatus 100 and the base station apparatus 200. The CPU 912 and the memory 913 perform wireless signal processing relating to wireless communication, including call control, incoming and outgoing control, and baseband processing. Additionally, the CPU 912 receives a control signal from the base station apparatus 100 and the base station apparatus 200 and achieves a function of performing processing in accordance with the control. Specifically, the CPU 912 achieves functions of receiving a CSI measurement request, performing CSI measurement with respect to the signals received by the RF circuit 911, and transmitting CSI measurements to the request originator via the RF circuit 911.

In one embodiment, the wireless communication system, the base station apparatus, and the method for controlling a wireless communication system disclosed in this application can achieve an effect of being capable of determining a cell boundary appropriately.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication system, comprising:
a first base station apparatus that forms a first wireless area; and
a second base station apparatus that forms a second wireless area having an overlapping area with the first wireless area,
the first base station apparatus including:
a first configuration changing unit that executes a configuration change for the first wireless area or the second wireless area;
a terminal count acquiring unit that obtains, when the first configuration changing unit has executed the configuration change, a count of wireless mobile terminal devices located in the overlapping area between the first wireless area and the second wireless area; and
a configuration fixing unit that fixes a configuration of the first wireless area or the second wireless area, or configurations of both of the first wireless area and the second wireless area, based on the count of the wireless mobile terminal devices located in the overlapping area, the count having been obtained by the terminal count acquiring unit.

2. The wireless communication system according to claim 1, wherein
the first configuration changing unit changes a size of the first wireless area in a stagewise fashion,
the terminal count acquiring unit obtains, for each stage of the size of the first wireless area, a count of the wireless mobile terminal devices that are located in the overlapping area and that satisfy a first predetermined condition, based on reception quality of the wireless mobile terminal devices located in the first wireless area or the second wireless area at each stage of the size of the first wireless area, and
the configuration fixing unit fixes the configurations of the first wireless area and the second wireless area, the configurations resulting in a minimum count of the wireless mobile terminal devices located in the overlapping area, based on the count of the wireless mobile terminal devices that are located in the overlapping area and that satisfy the first predetermined condition at each stage of the size of the first wireless area, the count having been obtained by the terminal count acquiring unit.

3. The wireless communication system according to claim 2, wherein the terminal count acquiring unit identifies the wireless mobile terminal devices that satisfy the first predetermined condition based on reception quality of signals from the first base station apparatus at the wireless mobile terminal devices connected with the one second base station apparatus and reception quality of signals from the one second base station apparatus at the wireless mobile terminal devices connected with the first base station apparatus.

4. The wireless communication system according to claim 2, wherein the configuration fixing unit determines whether the overlapping area exists, based on communication quality between the wireless mobile terminal devices located in the first wireless area and the second wireless area that have configurations changed to the fixed configurations, and the first base station apparatus and the one second base station apparatus, and when the overlapping area is determined not to exist, the configuration fixing unit expands the size of the second wireless area.

5. The wireless communication system according to claim 2, wherein
the one second base station apparatus includes a second configuration changing unit that changes a size of the second wireless area in a stagewise fashion in accordance with an instruction issued from the first configuration changing unit to execute the configuration change for the second wireless area,
the first configuration changing unit executes the configuration change for the second wireless area by notifying the second configuration changing unit of the configuration change for the second wireless area,
the terminal count acquiring unit obtains, for each stage of the size of the second wireless area, a count of the wireless mobile terminal devices that are located in the overlapping area and that satisfy a second predetermined condition, based on reception quality of the wireless mobile terminal devices located in the first wireless area or the second wireless area at each stage of the size of the second wireless area, and
the configuration fixing unit fixes the configurations of the first wireless area and the second wireless area such that the count of the wireless mobile terminal devices located in the overlapping area is a minimum, based on the count of the wireless mobile terminal devices that are located in the overlapping area and that satisfy the first predetermined condition at each stage of the size of the first wireless area and the count of the wireless mobile terminal devices that are located in the overlapping area and that satisfy the second predetermined condition at each stage of the size of the second wireless area, the counts having been obtained by the terminal count acquiring unit.

6. The wireless communication system according to claim 5, wherein the configuration fixing unit fixes a configuration that involves a smaller difference in counts between the wireless mobile terminal devices connected to the first base station apparatus and to the one second base station apparatus when the sizes of the first wireless area and the second wireless area are changed, out of the stages that result in a minimum count of the wireless mobile terminal devices located in the overlapping area at each stage of the size of the first wireless area and a minimum count of the wireless mobile terminal devices located in the overlapping area at each stage of the size of the second wireless area.

7. The wireless communication system according to claim 1, further comprising a plurality of second base station apparatuses; wherein
the first configuration changing unit expands each of the second wireless areas, and
the configuration fixing unit divides the first wireless area such that a difference in counts is small among the wireless mobile terminal devices located in each wireless area after the division, based on the count of the wireless mobile terminal devices located in the overlapping area, the count having been obtained by the terminal count acquiring unit.

8. A base station apparatus, comprising:
a configuration changing unit that executes a configuration change for a first wireless area formed by the host base station apparatus or a second wireless area that is formed by another base station apparatus and that has an overlapping area with the first wireless area;
a terminal count acquiring unit that obtains, when the configuration changing unit has executed the configuration change, a count of wireless mobile terminal devices located in the overlapping area between the first wireless area and the second wireless area; and
a configuration fixing unit that fixes a configuration of the first wireless area or the second wireless area, or configurations of both of the first wireless area and the second wireless area, based on the count of the wireless mobile terminal devices located in the overlapping area, the count having been obtained by the terminal count acquiring unit.

9. A method for controlling a wireless communication system, the wireless communication system including a first base station apparatus that forms a first wireless area and a second base station apparatus that forms a second wireless area having an overlapping area with the first wireless area, the method comprising:
executing a configuration change for the first wireless area or the second wireless area;
obtaining, when the configuration change for the first wireless area or the second wireless area has been executed, a count of wireless mobile terminal devices located in the overlapping area between the first wireless area and the second wireless area; and
fixing a configuration of the first wireless area or the second wireless area, or configurations of both of the first wireless area and the second wireless area, based on the count of the wireless mobile terminal devices located in the overlapping area.
